(19) United States
(12) Patent Application Publication
(10) Pub. No.: US 2011/0253929 A1
(43) Pub. Date: Oct. 20, 2011

(54) MIXTURES OF HYDROPHOBIC AND HYDROPHILIC IONIC LIQUIDS AND USE THEREOF IN LIQUID RING COMPRESSORS

(75) Inventors: Christoph Stock, Ellerstadt (DE); Juergen Pongratz, Mannheim (DE)

(73) Assignee: BASF SE, Ludwigshafen (DE)

(21) Appl. No.: 13/141,547

(22) PCT Filed: Dec. 21, 2009
(86) PCT No.: PCT/EP2009/067607

§ 371 Date: Jun. 22, 2011

(30) Foreign Application Priority Data
Dec. 22, 2008 (EP) 08172582.2

(51) Int. Cl. C09K 3/00; B01J 3/00

(52) U.S. Cl. 252/182.3

(57) ABSTRACT

The present invention relates to mixtures comprising a hydrophilic and at least one hydrophobic ionic liquid, to the use thereof as a working fluid in liquid ring compressors and to a corresponding method.

The present invention relates to mixtures comprising at least one hydrophilic ionic liquid and at least one hydrophobic ionic liquid, their use as operating liquid in liquid ring compressors and also corresponding methods.

Ionic liquids have a series of interesting properties. For example, they have an extremely low, barely measurable vapor pressure, are nonflammable and have very good solvent properties for numerous substances. In addition, owing to their purely ionic structure, they also have interesting electrochemical properties such as the electrical conductivity which is frequently accompanied by a high electrochemical stability. Furthermore, properties such as the melting point or the solubility in water or organic solvents can largely be determined at will via the type of cation or anion or by structural variation of particular classes of anions or cations, e.g. by variation of the side chains. Introduction of functional groups enables ionic liquids also to be used as acids, bases or ligands.

The molecular variety of ionic liquids makes it possible for them to be used in many industrial fields of application. Examples are extraction (e.g. isolation and purification of industrial gases, isolation and purification of hydrocarbons in the petrochemicals industry and in organic synthesis or the removal of toxic substances from wastewater), the sorption, drying, purification and storage of gases (e.g. in sorptive air conditioning units), use as solvents (e.g. for organic synthesis), the immobilization of catalysts and use as lubricant, hydraulic fluid or antistatic additive.

This variety of specific industrial fields of application for ionic liquids is associated with a continuing need to match the properties of ionic liquids to the specific use.

An important industrial field is the compression and evacuation of gases. Here, liquid ring compressors are widely used. They are used firstly to compress gases and secondly they can also be used as vacuum pump for the evacuation of reactors, vessels or other plant components.

In a liquid ring compressor, an impeller with attached blades is arranged eccentrically in a housing. An operating liquid is present in the housing and is flung against the wall of the housing by rotation of the impeller as a result of the centrifugal forces which occur. In this way, the operating liquid forms a circumferential liquid ring in the housing by means of which chambers which are each bounded by two blades and the liquid ring are formed. Owing to the eccentric arrangement of the impeller in the housing, the size of the chambers decreases in the direction in which the impeller runs. The formation of the liquid ring results in a reduced pressure occurring in the chambers. This sucks in gas. Owing to the rotation of the impeller and the reduction in size of the chambers, the gas which has been sucked in is compressed and pushed out of the liquid ring compressor on the pressure side.

Such a liquid ring compressor is known, for example, from Wilhelm R. A. Vauck, Grundoperationen chemischer Verfahrenstechnik, 11th revised and expanded edition, Deutscher Verlag für Grundstoffindustrie, Stuttgart, 2000.

Customary operating liquids which are used for operation of the liquid ring compressor are, for example, water, organic solvents or oils. These operating liquids are associated with disadvantages. Thus, they have a vapor pressure which, firstly, represents the limit for the lowest pressure which can be achieved on the suction side of the liquid ring compressor and, secondly, has the effect that vaporized operating liquid contaminates the compressed gas and is discharged with it from the compressor. A further disadvantage is the tendency of the operating liquids mentioned to display cavitation, especially when they comprise liquid or gaseous impurities. This can result in an adverse effect on the compressor performance, to noise pollution and even to damage to the compressor. For the present purposes, cavitation is the formation and disappearance of voids in the operating liquid of a liquid ring compressor, with the disappearance being able to be associated with bubble implosion (microscopic vapor shock). The voids are generally formed during rapid motion of the impeller in the operating liquid by outgassing or vaporization of gases or liquids, for example water, dissolved in the operating liquid.

WO 2006/029884 discloses the use of ionic liquids as operating liquid for liquid ring compressors. Since ionic liquids have a very low or unmeasurable vapor pressure, lower pressures can be achieved when they are used in liquid ring compressors. However, the ionic liquids described in WO 2006/029884 are not able to alleviate the problem of cavitation to a sufficient extent.

It was therefore an object of the present invention to provide ionic liquids or mixtures of ionic liquids which are suitable as operating liquid for liquid ring compressors and do not have the abovementioned disadvantages. They should, in particular, also be suitable for the evacuation of gases such as water vapor which themselves promote cavitation or for the evacuation of gas mixtures which comprise such components which promote cavitation. A further object of the invention was to provide corresponding methods and uses.

It has now surprisingly been found that mixtures of hydrophilic and hydrophobic ionic liquids are able to substantially suppress cavitation under the usual operating conditions of liquid ring compressors.

The present invention therefore firstly provides a mixture of ionic liquids comprising
at least one ionic liquid ILa which is completely miscible with water at 20° C. and 1013 mbar and
at least one ionic liquid ILb which has a miscibility gap with water at 20° C. and 1013 mbar.

For the purposes of the present invention, “completely miscible with water” means that an ionic liquid IL is miscible in any ratio with water to form a homogeneous liquid under standard conditions, i.e. 20° C. and 1013 mbar. In other words, the mixture does not have any miscibility gap over the entire composition range from >0% of water (or <100% of IL) to <100% of water (or >0% of IL).

Consequently, “having a miscibility gap with water” means that the abovementioned composition range of the mixture of an ionic liquid IL with water has at least one section in which the one homogeneous phase has separated into two or more phases.

As a person skilled in the art will readily be able to see, ionic liquids ILa and ILb which are suitable for the purposes of the invention can accordingly be identified by simple mixing experiments which are quick to carry out.

For the purposes of the present patent application, ionic liquids are organic salts which are liquid at temperatures below 180° C. In general, the melting points of the ionic liquids are in the range from −50° C. to 180° C., preferably in the range from −20° C. to 150° C., in particular in the range from −10° C. to 120° C. and especially in the range from 0° C. to 100° C.

Cations and anions are present in the ionic liquids. Here, a proton or an alkyl radical can be transferred from the cation to the anion in an ionic liquid, resulting in two uncharged molecules. An equilibrium of anions, cations and uncharged molecules formed therefrom can thus be present in the ionic liquids used according to the invention.

The ionic liquids ILa and ILb used according to the invention can differ from one another in terms of the cation, the anion or both. The ionic liquids ILa and ILb can be selected quite generally according to their hydrophilicity/hydrophobicity from those mentioned below.

For the purposes of the present invention, the expression “alkyl” comprises straight-chain or branched alkyl. The alkyl group is preferably straight-chain or branched C₁-C₃₀-alkyl, in particular C₁-C₁₈-alkyl and very particularly preferably C₁-C₁₂-alkyl.

Examples of alkyl groups are, in particular, methyl, ethyl, n-propyl, isopropyl, n-butyl, Isobutyl, sec-butyl, tert-butyl, n-pentyl, isopentyl, 1-methylbutyl, tert-pentyl, neopentyl, n-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, n-heptyl, n-octyl, 1-methylheptyl, 2-ethylhexyl, 2,4,4-trimethylpentyl, 1,1,3,3-tetramethylbutyl, n-nonyl, n-decyl, n-undecyl, n-dodecyl, n-tridecyl, n-tetradecyl, n-pentadecyl, n-hexadecyl, n-heptadecyl, n-octadecyl and n-eicosyl.

The expression alkyl also comprises alkyl radicals whose carbon chain can be interrupted by one or more nonadjacent heteroatoms or heteroatom-comprising groups which are preferably selected from among —O—, —S—, —NRa—, —PRa—, —SiR^{a}R^{aa}—, —OSi(R^{a})(R^{aa})—, —OSi(R^{a})(R^{aa})O—, —SO₂—, —SO₄— and/or —OP(═O)(OR^{a})O—, R^{a} is preferably hydrogen, alkyl, cycloalkyl, heterocycloalkyl, aryl or hetaryl. R^{aa} is preferably hydrogen, alkyl, cycloalkyl, heterocycloalkyl or aryl.

Examples of alkyl radicals whose carbon chains can be interrupted by one or two nonadjacent heteroatoms —O— are the following:

methoxymethyl, diethoxymethyl, 2-methoxyethyl, 2-ethoxyethyl, 2-propoxyethyl, diethoxyethyl, 2-butoxyethyl, 2-octyloxyethyl, 2-methoxypropyl, 3-methoxypropyl, 3-ethoxypropyl, 3-propoxypropyl, 2-isopropoxyethyl, 2-butoxypropyl, 3-butoxypropyl, 4-methoxybutyl, 4-ethoxybutyl, 4-propoxybutyl, 6-methoxyhexyl, 3,6-dioxaheptyl (5-methoxy-3-oxapentyl), 3,6-dioxaoctyl (7-methoxy-4-oxaheptyl), 4,8-dioxanonyl (7-methoxy-4-oxaheptyl), 3,7-dioxaoctyl, 3,7-dioxanonyl, 4,7-dioxaoctyl, 4,7-dioxanonyl, 2- and 4-butoxybutyl, 4,8-dioxadecyl, 9-ethoxy-5-oxa-nonyl.

Examples of alkyl radicals whose carbon chains can be interrupted by three or more than three nonadjacent heteroatoms —O— are also oligooxyalkylenes and polyoxyalkylenes, i.e. compounds having repeating units which are preferably selected from among (CH₂CH₂O)ₓ₁, (CH(CH₃)CH₂O)ₓ₂ and ((CH₂)₄O)ₓ₃, where x1, x2 and x3 are each, independently of one another, an integer from 3 to 100, preferably from 3 to 80. The sum of x1, x2 and x3 is an integer from 3 to 300, in particular from 3 to 100. In polyoxyalkylenes which have two or three different repeating units, the order is immaterial, i.e. the repeating units can be arranged randomly, alternately or in blocks. Examples are 3,6,9-trioxadecyl, 3,6,9-trioxaundecyl, 3,6,9-trioxadodecyl, 4,8,12-trioxatridecyl (11-methoxy-4,8-dioxaundecyl), 4,8,12-trioxatetradecyl, 14-methoxy-5,10-dioxatetradecyl, 5,10,15-trioxaheptadecyl, 3,6,9,12-tetraoxatridecyl, 3,6,9,12-tetraoxatetradecyl, 4,8,12,16-tetraoxaheptadecyl (15-methoxy-4,8,12-trioxapentadecyl), 4,8,12,16-tetraoxaoctadecyl and the like.

Examples of alkyl radicals whose carbon chains can be interrupted by one or more, e.g. 1, 2, 3, 4 or more than 4, nonadjacent heteroatoms —S— are the following:

butylthiomethyl, 2-methylthioethyl, 2-ethylthioethyl, 2-propylthioethyl, 2-butylthioethyl, 2-dodecylthioethyl, 3-methylthiopropyl, 3-ethylthiopropyl, 3-propylthiopropyl, 3-butylthiopropyl, 4-methylthiobutyl, 4-ethylthiobutyl, 4-propylthiobutyl, 3,6-dithiaheptyl, 3,6-dithiaoctyl, 4,8-dithianonyl, 3,7-dithiaoctyl, 3,7-dithianonyl, 2- and 4-butylthiobutyl, 4,8-dithiadecyl, 3,6,9-trithiadecyl, 3,6,9-trithiaundecyl, 3,6,9-trithiadodecyl, 3,6,9,12-tetrathiatridecyl and 3,6,9,12-tetrathiatetradecyl.

Examples of alkyl radicals whose carbon chains are interrupted by one or two nonadjacent heteroatom-comprising groups —NR^{a}— are the following:

2-monomethyl- and 2-monoethylaminoethyl, 2-dimethylaminoethyl, 3-methylamino-propyl, 2- and 3-dimethylaminopropyl, 3-monoisopropylaminopropyl, 2- and 4-monopropylaminobutyl, 2- and 4-dimethylaminobutyl, 6-methylaminohexyl, 6-dimethylaminohexyl, 6-methyl-3,6-diazaheptyl, 3,6-dimethyl-3,6-diazaheptyl, 3,6-diazaoctyl and 3,6-dimethyl-3,6-diazaoctyl.

Examples of alkyl radicals whose carbon chains can be interrupted by three or more than three nonadjacent heteroatom-comprising groups —NR^{a}— are also oligoalkyleneimines and polyalkyleneimines. What has been said above with regard to polyoxyalkylenes applies analogously to polyalkyleneimines, with the oxygen atom being in each case replaced by an NR^{a} group in which R^{a} is preferably hydrogen or C₁-C₄-alkyl. Examples are 9-methyl-3,6,9-triazadecyl, 3,6,9-trimethyl-3,6,9-triazadecyl, 3,6,9-triazaundecyl, 3,6,9-trimethyl-3,6,9-triazaundecyl, 12-methyl-3,6,9,12-tetraazatridecyl, 3,6,9,12-tetramethyl-3,6,9,12-tetraazatridecyl and the like.

Examples of alkyl radicals whose carbon chains are interrupted by one or more, e.g. 1 or 2, nonadjacent groups —SO₂— are 2-methylsulfonylethyl, 2-ethylsulfonylethyl, 2-propylsulfonylethyl, 2-isopropylsulfonylethyl, 2-butylsulfonylethyl, 2-methylsulfonylpropyl, 3-methylsulfonylpropyl, 2-ethylsulfonylpropyl, 3-ethylsulfonyl-propyl, 2-propylsulfonylpropyl, 3-propylsulfonylpropyl, 2-butylsulfonylpropyl, 3-butylsulfonylpropyl, 2-methylsulfonylbutyl, 4-methylsulfonylbutyl, 2-ethylsulfonylbutyl, 4-ethylsulfonylbutyl, 2-propylsulfonylbutyl, 4-propylsulfonylbutyl and 4-butylsulfonyl-butyl.

The expression alkyl also comprises substituted alkyl radicals. Substituted alkyl groups can have, depending on the length of the alkyl chain, one or more (e.g. 1, 2, 3, 4, 5 or more than 5) substituents. These are preferably selected independently from among cycloalkyl, cycloalkyloxy, polycyclyl, polycyclyloxy, heterocycloalkyl, aryl, aryloxy, arylthio, hetaryl, halogen, hydroxy, SH, ═O, ═S, ═NR^{a}, COOH, carboxylate, SO₃H, sulfonate, NE¹E², nitro and cyano, where E¹ and E² are each, independently of one another, hydrogen, alkyl, cycloalkyl, heterocycloalkyl, aryl or hetaryl. Cycloalkyl, cycloalkyloxy, polycycloalkyl, polycycloalkyloxy, heterocycloalkyl, aryl and hetaryl substituents of the alkyl groups may in turn be unsubstituted or substituted; suitable substituents are those mentioned below for these groups.

What has been said above with regard to alkyl also applies in principle to the alkyl parts of alkoxy, alkylamino, dialkylamino, alkylthio (alkylsulfanyl), alkylsulfinyl, alkylsulfonyl, etc.

Suitable substituted alkyl radicals are the following:

alkyl which is substituted by carboxy, e.g. carboxymethyl, 2-carboxyethyl, 3-carboxypropyl, 4-carboxybutyl, 5-carboxypentyl, 6-carboxyhexyl, 7-carboxyheptyl, 8-carboxyoctyl, 9-carboxynonyl, 10-carboxydecyl, 12-carboxydodecyl and 14-carboxy-tetradecyl;

alkyl which is substituted by SO3R, where R is H, a cation equivalent or an alkyl radical. Examples of SO₃R-substituted alkyl are sulfomethyl, 2-sulfoethyl, 3-sulfopropyl, 4-sulfobutyl, 5-sulfopentyl, 6-sulfohexyl, 7-sulfoheptyl, 8-sulfooctyl, 9-sulfononyl, 10-sulfodecyl, 12-sulfododecyl, 14-sulfotetradecyl, methylsulfomethyl, methylsulfopropyl and sodium sulfoethyl; where a cation equivalent is, for the purposes of the invention, a monovalent cation or the part of a polyvalent cation corresponding to a single positive charge. The cation M+ serves merely as counter ion to neutralize the sulfonate group and can in principle be selected freely. Preference is therefore given to using alkali metal ions, in particular Na+, K+−, Li+ ions, or onium ions such as ammonium, monoalkylammonium, dialkylammonium, trialkylammonium, tetraalkylammonium, phosphonium, tetraalkylphosphonium or tetraarylphosphonium ions;

alkyl which is substituted by carboxylate, for example alkoxycarbonylalkyl, e.g. methoxycarbonylmethyl, ethoxycarbonylmethyl, n-butoxycarbonylmethyl, 2-methoxycarbonylethyl, 2-ethoxycarbonylethyl, 2-methoxycarbonylpropyl, 2-ethoxycarbonylpropyl, 2-(n-butoxycarbonyl)propyl, 2-(4-n-butoxycarbonyl)propyl, 3-methoxycarbonylpropyl, 3-ethoxycarbonylpropyl, 3-(n-butoxycarbonyl)propyl, 3-(4-n-butoxycarbonyl)propyl, aminocarbonylalkyl, e.g. aminocarbonylmethyl, aminocarbonylethyl, aminocarbonylpropyl and the like, alkylaminocarbonylalkyl such as methylaminocarbonylmethyl, methylaminocarbonylethyl, ethylcarbonylmethyl, ethylcarbonylethyl and the like or dialkylaminocarbonylalkyl such as dimethylaminocarbonylmethyl, dimethylaminocarbonylethyl, dimethylcarbonylpropyl, diethylaminocarbonylmethyl, diethylaminocarbonylethyl, diethylcarbonylpropyl and the like;

alkyl which is substituted by hydroxyl, e.g. 2-hydroxyethyl, 2-hydroxypropyl, 3-hydroxypropyl, 3-hydroxybutyl, 4-hydroxybutyl, 2-hydroxy-2,2-dimethylethyl, 5-hydroxy-3-oxapentyl, 6-hydroxyhexyl, 7-hydroxy-4-oxaheptyl, 8-hydroxy-4-oxaoctyl, 8-hydroxy-3,6-dioxaoctyl, 9-hydroxy-5-oxanonyl, 11-hydroxy-4,8-dioxaundecyl, 11-hydroxy-3,6,9-trioxaundecyl, 14-hydroxy-5,10-dioxatetradecyl, 15-hydroxy-4,8,12-trioxapentadecyl and the like;

alkyl which is substituted by amino, e.g. 2-aminoethyl, 2-aminopropyl, 3-aminopropyl, 4-aminobutyl, 6-aminohexyl and the like;

alkyl which is substituted by cyano, e.g. 2-cyanoethyl, 3-cyanopropyl, 3-cyanobutyl and 4-cyanobutyl;

alkyl which is substituted by halogen as defined below, where the hydrogen atoms in the alkyl group can be partly or completely replaced by halogen atoms, for example C₁-C₁₈-fluoroalkyl, e.g. trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl and the like, C₁-C₁₈-chloroalkyl, e.g. chloromethyl, dichloromethyl, trichloromethyl, 2-chloroethyl, 2- and 3-chloropropyl, 2-, 3- and 4-chlorobutyl, 1,1-dimethyl-2-chloroethyl and the like, C₁-C₁₈-bromoalkyl, e.g. bromoethyl, 2-bromoethyl, 2- and 3-bromopropyl and 2-, 3- and 4-bromobutyl and the like;

alkyl which is substituted by nitro, e.g. 2-nitroethyl, 2- and 3-nitropropyl and 2-, 3- and 4-nitrobutyl and the like;

alkyl which is substituted by amino, e.g. 2-aminoethyl, 2-aminopropyl, 3-aminopropyl, 4-aminobutyl, 6-aminohexyl and the like;

alkyl which is substituted by cycloalkyl, e.g. cyclopentylmethyl, 2-cyclopentylethyl, 3-cyclopentylpropyl, cyclohexylmethyl, 2-cyclohexylethyl, 3-cyclohexylpropyl and the like;

alkyl which is substituted by ═O (oxo group), e.g. 2-oxopropyl, 2-oxobutyl, 3-oxobutyl, 1-methyl-2-oxopropyl, 2-oxopentyl, 3-oxopentyl, 1-methyl-2-oxobutyl, 1-methyl-3-oxobutyl, 2-oxohexyl, 3-oxohexyl, 4-oxohexyl, 2-oxoheptyl, 3-oxoheptyl, 4-oxoheptyl and the like;

alkyl which is substituted by ═S (thioxo group), e.g. 2-thioxopropyl, 2-thioxobutyl, 3-thioxobutyl, 1-methyl-2-thioxopropyl, 2-thioxopentyl, 3-thioxopentyl, 1-methyl-2-thioxobutyl, 1-methyl-3-thioxobutyl, 2-thioxohexyl, 3-thioxohexyl, 4-thioxohexyl, 2-thioxoheptyl, 3-thioxoheptyl, 4-thioxoheptyl and the like;

alkyl which is substituted by ═NR^{a}—, preferably one in which R^{a} is hydrogen or C₁-C₄-alkyl, e.g. 2-iminopropyl, 2-iminobutyl, 3-iminobutyl, 1-methyl-2-iminopropyl, 2-iminopentyl, 3-iminopentyl, 1-methyl-2-iminobutyl, 1-methyl-3-iminobutyl, 2-iminohexyl, 3-iminohexyl, 4-iminohexyl, 2-iminoheptyl, 3-iminoheptyl, 4-iminoheptyl, 2-methyliminopropyl, 2-methyliminobutyl, 3-methyliminobutyl, 1-methyl-2-methyliminopropyl, 2-methyliminopentyl, 3-methyliminopentyl, 1-methyl-2-methyliminobutyl, 1-methyl-3-methyliminobutyl, 2-methyliminohexyl, 3-methyliminohexyl, 4-methyliminohexyl, 2-methyliminoheptyl, 3-methyliminoheptyl, 4-methyliminoheptyl, 2-ethyliminopropyl, 2-ethyliminobutyl, 3-ethyliminobutyl, 1-methyl-2-ethyliminopropyl, 2-ethyliminopentyl, 3-ethyliminopentyl, 1-methyl-2-ethyliminobutyl, 1-methyl-3-ethyliminobutyl, 2-ethyliminohexyl, 3-ethyliminohexyl, 4-ethyliminohexyl, 2-ethyliminoheptyl, 3-ethyliminoheptyl, 4-ethyliminoheptyl, 2-propyliminopropyl, 2-propyliminobutyl, 3-propyliminobutyl, 1-methyl-2-propyliminopropyl, 2-propyliminopentyl, 3-propyliminopentyl, 1-methyl-2-propyliminobutyl, 1-methyl-3-propyliminobutyl, 2-propyliminohexyl, 3-propyliminohexyl, 4-propyliminohexyl, 2-propyliminoheptyl, 3-propyliminoheptyl, 4-propyliminoheptyl and the like.

Alkoxy is an alkyl group bound via an oxygen atom. Examples of alkoxy are: methoxy, ethoxy, n-propoxy, 1-methylethoxy, butoxy, 1-methylpropoxy, 2-methylpropoxy, 1,1-dimethylethoxy, n-pentoxy, 1-methylbutoxy, 2-methylbutoxy, 3-methylbutoxy, 1,1-dimethylpropoxy, 1,2-dimethylpropoxy, 2,2-dimethylpropoxy, 1-ethylpropoxy, hexoxy, 1-methylpentoxy, 2-methylpentoxy, 3-methylpentoxy, 4-methylpentoxy, 1,1-dimethylbutoxy, 1,2-dimethylbutoxy, 1,3-dimethylbutoxy, 2,2-dimethylbutoxy, 2,3-dimethylbutoxy, 3,3-dimethylbutoxy, 1-ethylbutoxy, 2-ethylbutoxy, 1,1,2-trimethylpropoxy, 1,2,2-trimethylpropoxy, 1-ethyl-1-methylpropoxy or 1-ethyl-2-methylpropoxy, hexoxy and also R^{A}O—(CH₂CH₂CH₂CH₂O)ₙ—CH₂CH₂CH₂CH₂O— where R^{A} is hydrogen or C₁-C₄-alkyl, preferably hydrogen, methyl or ethyl and n is from 0 to 10, preferably from 0 to 3.

Alkylthio (alkylsulfanyl) is an alkyl group bound via a sulfur atom. Examples of alkylthio are methylthio, ethylthio, propylthio, butylthio, pentylthio and hexylthio.

Alkylsulfinyl is an alkyl group bound via an S(═O) group.

Alkylsulfonyl is an alkyl group bound via an S(═O)₂ group.

Aryl-substituted alkyl radicals (“arylalkyl”) have at least one unsubstituted or substituted aryl group as defined below. Suitable substituents on the aryl group are those mentioned below. Here, the alkyl group in “arylalkyl” can bear at least one further substituent as defined above and/or be interrupted by one or more nonadjacent heteroatoms or heteroatom-comprising groups selected from among —O—, —S—, —NR^{a}— and/or —SO₂—. Arylalkyl is preferably phenyl-C₁-C₁₀-alkyl, particularly preferably phenyl-C₁-C₄-alkyl, e.g. benzyl, 1-phenethyl, 2-phenethyl, 1-phenprop-1-yl, 2-phenprop-1-yl, 3-phenprop-1-yl, 1-phenbut-1-yl, 2-phenbut-1-yl, 3-phenbut-1-yl, 4-phenbut-1-yl, 1-phenbut-2-yl, 2-phenbut-2-yl, 3-phenbut-2-yl, 4-phenbut-2-yl, 1-(phenmeth)eth-1-yl, 1-(phenmethyl)-1-(methypeth-1-yl or -(phenmethyl)-1-(methyl)prop-1-yl; preferably benzyl and 2-phenethyl.

For the purposes of the present invention, the expression “alkenyl” comprises straight-chain and branched alkenyl groups which, depending on the chain length, can bear one or more double bonds (e.g. 1, 2, 3, 4 or more than 4). Preference is given to C₂-C₁₈—, particularly preferably C₂-C₁₂-alkenyl groups. The expression “alkenyl” also comprises substituted alkenyl groups which can bear one or more (e.g. 1, 2, 3, 4, 5 or more than 5) substituents. Suitable substituents are, for example, selected from among ═O, ═S, ═NR^{a}, cycloalkyl, cycloalkyloxy, polycyclyl, polycyclyloxy, heterocycloalkyl, aryl, aryloxy, arylthio, hetaryl, halogen, hydroxy, SH, COOH, carboxylate, SO₃H, sulfonate, alkylsulfinyl, alkylsulfonyl, NE³E⁴, nitro and cyano, where E³ and E⁴ are each, independently of one another, hydrogen, alkyl, cycloalkyl, heterocycloalkyl, aryl or hetaryl.

The expression “alkenyl” also comprises alkenyl radicals whose carbon chain can be interrupted by one or more nonadjacent heteroatoms or heteroatom-comprising groups which are preferably selected from among —O—, —S—, —NR^{a}— and —SO₂—.

Alkenyl is then, for example, ethenyl (vinyl), 1-propenyl, 2-propenyl, 1-methylethenyl, 1-butenyl, 2-butenyl, 3-butenyl, 1-pentenyl, 2-pentenyl, 3-pentenyl, 4-pentenyl, 1-hexenyl, 2-hexenyl, 3-hexenyl, 4-hexenyl, 5-hexenyl, penta-1,3-dien-1-yl, hexa-1,4-dien-1-yl, hexa-1,4-dien-3-yl, hexa-1,4-dien-6-yl, hexa-1,5-dien-1-yl, hexa-1,5-dien-3-yl, hexa-1,5-dien-4-yl, hepta-1,4-dien-1-yl, hepta-1,4-dien-3-yl, hepta-1,4-dien-6-yl, hepta-1,4-dien-7-yl, hepta-1,5-dien-1-yl, hepta-1,5-dien-3-yl, hepta-1,5-dien-4-yl, hepta-1,5-dien-7-yl, hepta-1,6-dien-1-yl, hepta-1,6-dien-3-yl, hepta-1,6-dien-4-yl, hepta-1,6-dien-5-yl, hepta-1,6-dien-2-yl, octa-1,4-dien-1-yl, octa-1,4-dien-2-yl, octa-1,4-dien-3-yl, octa-1,4-dien-6-yl, octa-1,4-dien-7-yl, octa-1,5-dien-1-yl, octa-1,5-dien-3-yl, octa-1,5-dien-4-yl, octa-1,5-dien-7-yl, octa-1,6-dien-1-yl, octa-1,6-dien-3-yl, octa-1,6-dien-4-yl, octa-1,6-dien-5-yl, octa-1,6-dien-2-yl, deca-1,4-dienyl, deca-1,5-dienyl, deca-1,6-dienyl, deca-1,7-dienyl, deca-1,8-dienyl, deca-2,5-dienyl, deca-2,6-dienyl, deca-2,7-dienyl, deca-2,8-dienyl and the like.

For the purposes of the present invention, the expression “cycloalkyl” comprises both unsubstituted and substituted monocyclic saturated hydrocarbon groups which generally have from 3 to 12 ring carbons, preferably C₃-C₁₂-cycloalkyl groups such as cyclopropyl, cyclobutyl, cyclopentyl, cyclohexyl, cycloheptyl, cyclooctyl, cyclononyl, cyclodecyl, cycloundecyl or cyclododecyl, in particular C₅-C₁₂-cycloalkyl. Suitable substituents are generally selected from among alkyl, the substituents mentioned above for the alkyl groups, alkoxy and alkylthio. Substituted cycloalkyl groups can have one or more (e.g. 1, 2, 3, 4, 5 or more than 5) substituents, in the case of halogen the cycloalkyl radical being partially or completely substituted by halogen.

Examples of cycloalkyl groups are cyclopentyl, 2- and 3-methylcyclopentyl, 2- and 3-ethylcyclopentyl, chioropentyl, dichloropentyl, dimethylcyclopentyl, cyclohexyl, 2-, 3- and 4-methylcyclohexyl, 2-, 3- and 4-ethylcyclohexyl, 3- and 4-propylcyclohexyl, 3- and 4-isopropylcyclohexyl, 3- and 4-butylcyclohexyl, 3- and 4-sec-butylcyclohexyl, 3- and 4-tert-butylcyclohexyl, chlorohexyl, dimethylcyclohexyl, diethylcyclohexyl, methoxy-cyclohexyl, dimethoxycyclohexyl, diethoxycyclohexyl, butoxycyclohexyl, methylthiocyclohexyl, chlorocyclohexyl, dichlorocyclohexyl, cycloheptyl, 2-, 3- and 4-methylcycloheptyl, 2-, 3- and 4-ethylcycloheptyl, 3- and 4-propylcycloheptyl, 3- and 4-isopropylcycloheptyl, 3- and 4-butylcycloheptyl, 3- and 4-sec-butylcycloheptyl, 3- and 4-tert-butylcycloheptyl, cyclooctyl, 2-, 3-, 4- and 5-methylcyclooctyl, 2-, 3-, 4- and 5-ethylcyclooctyl, 3-, 4- and 5-propylcyclooctyl, partially fluorinated cycloalkyl and perfluorinated cycloalkyl of the formula CₙF_{2(n-a)-(1-b)}H_{2a-b} where n=5 to 12, 0≦a<n and b=0 or 1, where n and a are integers and in the case of a=0, b is also 0.

Cycloalkyloxy is a cycloalkyl group as defined above bound via oxygen.

The expression “cycloalkenyl” comprises unsubstituted and substituted, monounsaturated or doubly unsaturated hydrocarbon groups having from 3 to 5, from 3 to 8, from 3 to 12, preferably from 5 to 12, ring carbons, e.g. cyclopent-1-en-1-yl, cyclopent-2-en-1-yl, cyclopent-3-en-1-yl, cyclohex-1-en-1-yl, cyclohex-2-en-1-yl, cyclohex-3-en-1-yl, cyclohexa-2,5-dien-1-yl and the like. Suitable substituents are those mentioned above for cycloalkyl.

Cycloalkenyloxy is a cycloalkenyl group as defined above bound via oxygen.

For the purposes of the present invention, the expression “polycyclyl” comprises in the widest sense compounds which comprise at least two rings, regardless of how these rings are linked. The rings can be carbocyclic and/or heterocyclic rings. The rings can be saturated or unsaturated. The rings can be linked via a single or double bond (“multiring systems”), be joined by fusion (“fused ring systems”) or be bridged (“bridged ring systems”, “cage compounds”). Preferred polycyclic compounds are bridged ring systems and fused ring systems. Fused ring systems can be aromatic, hydroaromatic and cyclic compounds joined by fusion (fused compounds). Fused ring systems comprise two, three or more than three rings. Depending on the way in which the rings are linked in fused ring systems, a distinction is made between ortho-fusion, i.e. each ring shares an edge or two atoms with each adjacent ring, and peri-fusion in which a carbon atom belongs to more than two rings. Among fused ring systems, preference is given to ortho-fused ring systems. Bridged ring systems include, for the purposes of the present invention, ones which do not belong to the multiring systems and not to the fused ring systems and in which at least two ring atoms belong to at least two different rings. In the case of bridged ring systems, a distinction is made according to the number of ring-opening reactions which are formally required to arrive at an open-chain compound between bicyclo, tricyclo, tetracyclo compounds, etc., which comprise two, three, four, etc. rings. For example, the expression “bicycloalkyl” comprises bicyclic hydrocarbon radicals which preferably have from 5 to 10 carbon atoms, e.g. bicyclo[2.2.1]hept-1-yl, bicyclo[2.2.1]hept-2-yl, bicyclo[2.2.1]hept-7-yl, bicyclo[2.2.2]oct-1-yl, bicyclo[2.2.2]oct-2-yl, bicyclo[3.3.0]octyl, bicyclo[4.4.0]decyl and the like. A further example is the expression “bicycloalkenyl” which comprises monounsaturated, bicyclic hydrocarbon radicals which preferably have from 5 to 10 carbon atoms, e.g. bicyclo[2.2.1]hept-2-en-1-yl.

For the purposes of the present invention, the expression “aryl” comprises aromatic hydrocarbon radicals which have one or more rings and can be unsubstituted or substituted. Aryl generally refers to hydrocarbon radicals having from 6 to 10, up to 14, up to 18, preferably from 6 to 10, ring carbons. Aryl is preferably unsubstituted or substituted phenyl, naphthyl, anthracenyl, phenanthrenyl, naphthacenyl, chrysenyl, pyrenyl, etc., and particularly preferably phenyl or naphthyl. Substituted aryls can, depending on the number and size of their ring systems, have one or more (e.g. 1, 2, 3, 4, 5 or more than 5) substituents. These are preferably selected independently from among alkyl, alkoxy, cycloalkyl, cycloalkyloxy, heterocycloalkyl, aryl, aryloxy, arylthio, hetaryl, halogen, hydroxy, SH, alkylthio, alkylsulfinyl, alkylsulfonyl, COOH, carboxylate, SO3H, sulfonate, NE⁵E⁶, nitro and cyano, where E⁵ and E⁶ are each, independently of one another, hydrogen, alkyl, cycloalkyl, cycloalkyloxy, polycyclyl, polycyclyloxy, heterocycloalkyl, aryl, aryloxy or hetaryl. Particular preference is given to aryl being phenyl which, if it is substituted, can generally bear 1, 2, 3, 4 or 5, preferably 1, 2 or 3, substituents.

Aryl which bears one or more radicals is, for example, 2-, 3- and 4-methylphenyl, 2,4-, 2,5-, 3,5- and 2,6-dimethylphenyl, 2,4,6-trimethylphenyl, 2-, 3- and 4-ethylphenyl, 2,4-, 2,5-, 3,5- and 2,6-diethylphenyl, 2,4,6-triethylphenyl, 2-, 3- and 4-propylphenyl, 2,4-, 2,5-, 3,5- and 2,6-dipropylphenyl, 2,4,6-tripropylphenyl, 2-, 3- and 4-isopropylphenyl, 2,4-, 2,5-, 3,5- and 2,6-diisopropylphenyl, 2,4,6-triisopropylphenyl, 2-, 3- and 4-butylphenyl, 2,4-, 2,5-, 3,5- and 2,6-dibutylphenyl, 2,4,6-tributylphenyl, 2-, 3- and 4-isobutylphenyl, 2,4-, 2,5-, 3,5- and 2,6-diisobutylphenyl, 2,4,6-triisobutylphenyl, 2-, 3- and 4-sec-butylphenyl, 2,4-, 2,5-, 3,5- and 2,6-di-sec-butylphenyl, 2,4,6-tri-sec-butylphenyl, 2-, 3- and 4-tert.-butylphenyl, 2,4-, 2,5-, 3,5- and 2,6-di-tert-butylphenyl, 2,4,6-tri-tert-butylphenyl and 2-, 3-, 4-dodecylphenyl; 2-, 3- and 4-methoxyphenyl, 2,4-, 2,5-, 3,5- and 2,6-dimethoxyphenyl, 2,4,6-trimethoxyphenyl, 2-, 3- and 4-ethoxyphenyl, 2,4-, 2,5-, 3,5- and 2,6-diethoxyphenyl, 2,4,6-triethoxyphenyl, 2-, 3- and 4-propoxyphenyl, 2,4-, 2,5-, 3,5- and 2,6-dipropoxyphenyl, 2-, 3- and 4-isopropoxyphenyl, 2,4-, 2,5-, 3,5- and 2,6-diisopropoxyphenyl, 2-, 3- and 4-butoxyphenyl, 2-, 3-, 4-hexyloxyphenyl; 2-, 3-, 4-chlorophenyl, 2,4-, 2,5-, 3,5- and 2,6-dichiorophenyl, trichlorophenyl, 2-, 3-, 4-fluorophenyl, 2,4-, 2,5-, 3,5- and 2,6-difluorophenyl, trifluorophenyl, e.g. 2,4,6-trifluorophenyl, tetrafluorophenyl, pentafluorophenyl, 2-, 3- and 4-cyanophenyl; 2-nitrophenyl, 4-nitrophenyl, 2,4-dinitrophenyl, 2,6-dinitrophenyl; 4-dimethylaminophenyl; 4-acetylphenyl; methoxyethylphenyl, ethoxymethylphenyl; methylthiophenyl, isopropylthiophenyl or tert-butylthiophenyl; methylnaphthyl; isopropylnaphthyl or ethoxynaphthyl. Examples of substituted aryl in which two substituents which are bound to adjacent carbon atoms of the aryl ring form a fused-on ring or fused ring system are indenyl and fluoroenyl.

For the purposes of the present invention, the expression “aryloxy” refers to aryl bound via an oxygen atom.

For the purposes of the present invention, the expression “arylthio” refers to aryl bound via a sulfur atom.

For the purposes of the present invention, the expression “heterocycloalkyl” comprises nonaromatic, unsaturated or fully saturated, cycloaliphatic groups which generally have from 5 to 8 ring atoms, preferably 5 or 6 ring atoms, and in which 1, 2 or 3 of the ring carbons have been replaced by heteroatoms selected from among oxygen, nitrogen, sulfur and an —NR^{a}— group and which is unsubstituted or substituted by one or more, for example, 1, 2, 3, 4, 5 or 6, C₁-C₆-alkyl groups. Examples of such heterocycloaliphatic groups are pyrrolidinyl, piperidinyl, 2,2,6,6-tetramethylpiperidinyl, imidazolidinyl, pyrazolidinyl, oxazolidinyl, morpholidinyl, thiazolidinyl, isothiazolidinyl, isoxazolidinyl, piperazinyl, tetrahydrothienyl, dihydrothienyl, tetrahydrofuranyl, dihydrofuranyl, tetrahydropyranyl, 1,2-oxazolin-5-yl, 1,3-oxazolin-2-yl and dioxanyl. Nitrogen-comprising heterocycloalkyl can in principle be bound either via a carbon atom or via a nitrogen atom.

For the purposes of the present invention, the expression “heteroaryl (hetaryl)” comprises unsubstituted or substituted, heteroaromatic groups which have one or more rings and generally have from 5 to 14 ring atoms, preferably 5 or 6 ring atoms, and in which 1, 2 or 3 of the ring carbons have been replaced by one, two, three or four heteroatoms selected from among O, N, —NR^{a}— and S, for example furyl, thienyl, oxazolyl, isoxazolyl, thiazolyl, isothiazolyl, benzofuranyl, benzthiazolyl, benzimidazolyl, pyridyl, quinolinyl, acridinyl, pyridazinyl, pyrimidinyl, pyrazinyl, pyrrolyl, imidazolyl, pyrazolyl, indolyl, purinyl, indazolyl, benzotriazolyl, 1,2,3-triazolyl, 1,3,4-triazolyl and carbazolyl, where these heterocycloaromatic groups can, if they are substituted, generally bear 1, 2 or 3 substituents. The substituents are generally selected from among C₁-C₆-alkyl, C₁-C₆-alkoxy, hydroxy, carboxy, halogen and cyano.

5- to 7-membered nitrogen-comprising heterocycloalkyl or heteroaryl radicals, which may optionally comprise further heteroatoms, are, for example, pyrrolyl, pyrazolyl, imidazolyl, triazolyl, pyrrolidinyl, pyrazolinyl, pyrazolidinyl, imidazolinyl, imidazolidinyl, pyridinyl, pyridazinyl, pyrimidinyl, pyrazinyl, triazinyl, piperidinyl, piperazinyl, oxazolyl, isooxazolyl, thiazolyl, isothiazolyl, indolyl, quinolinyl, isoquinolinyl or quinaldinyl, which can be unsubstituted or substituted as mentioned above.

Halogen is fluorine, chlorine, bromine or iodine.

For the purposes of the present invention, carboxylate and sulfonate are preferably derivatives of a carboxylic acid function or a sulfonic acid function, in particular a metal carboxylate or sulfonate, a carboxylic acid ester or sulfonic ester function or a carboxamide or sulfonamide function. These include, for example, esters with C₁-C₄-alkanols such as methanol, ethanol, n-propanol, isopropanol, n-butanol, sec-butanol and tert-butanol.

For the purposes of the present invention, the expression “acyl” refers to alkanoyl, hetaroyl or aroyl groups which generally have from 1 to 11, preferably from 2 to 8, carbon atoms, for example formyl, acetyl, propanoyl, butanoyl, pentanoyl, hexanoyl, heptanoyl, 2-ethylhexanoyl, 2-propylheptanoyl, benzoyl or naphthoyl group.

The radicals E¹, E², E³ and E⁴ are selected independently from among hydrogen, alkyl, cycloalkyl, heterocycloalkyl, aryl and hetaryl. The groups NE¹E² and NE³E⁴ are preferably N,N-dimethylamino, N,N-diethylamino, N,N-dipropylamino, N,N-diisopropylamino, N,N-di-n-butylamino, N,N-di-tert-butylamino, N,N-dicyclohexylamino or N,N-diphenylamino.

In a preferred embodiment of the invention, the cations of ILa and ILb are selected from the same group of cations, while the anions of ILa and ILb are each selected from different but possibly intersecting groups of anions.

In a particularly preferred embodiment of the invention, the cations of ILa and ILb are selected from the same group of cations, while the anions of ILa and ILb are each selected from different, nonintersecting groups of anions.

As ILa or ILb of the mixtures according to the invention, it is in principle possible to use all ionic liquids as long as these do not have or have a miscibility gap with water as explained above.

However, the ionic liquids ILa and ILb are preferably selected from among

(A) salts of the general formula (I)

[A]ₚ^{m+}[Y]_{q}ⁿ⁻ (I),
where:
m, n, p and q are each 1, 2, 3 or 4 and the product of p and m is equal to the product of q and n;
[A]^{m+} is a monovalent, divalent, trivalent or tetravalent cation or a cationic compound comprising two or more (e.g. 2, 3 or 4) cationic groups which are preferably selected independently from among ammonium groups, oxonium groups, sulfonium groups and phosphonium groups; and
[Y]ⁿ⁻ is a monovalent, divalent, trivalent or tetravalent anion or a mixture of these anions;
   (B) mixed salts of the general formulae (II)
[A¹]⁺ [A²]⁺ [Y]ⁿ⁻ (II.a), where n=2,
[A¹]⁺ [A²]⁺ [A³]⁺ [Y]ⁿ⁻ (II.b), where n=3,
[A¹]⁺ [A²]⁺ [A³]⁺ [A⁴]⁺ [Y]ⁿ⁻ (II.C), where n=4, and
where [A¹]⁺, [A²]⁺, [A³]⁺, and [A⁴]⁺ are selected independently from among the monovalent cations mentioned for [A]⁺ and [Y]ⁿ⁻ is as defined under (A); or
   (C) mixed salts of the general formulae (III)
[A¹]²⁺ [A²]⁺ [Y]ⁿ⁻ (III.a), where n=3,
[A¹]²⁺ [A²]⁺ [A³]⁺ [Y]ⁿ⁻ (III.b), where n=4,
[A¹]²⁺ [A⁴]²⁺ [Y]ⁿ⁻ (III.c), where n=4,
[A⁵]³⁺ [A²]⁺ [Y]ⁿ⁻ (III.d), where n=4,
[A¹]²⁺ [A²]⁺ [A³]⁺ [A⁶]⁺ [Y]ⁿ⁻ (III.e), where n=5,
[A¹]²⁺ [A⁴]²⁺ [A⁶]⁺ [Y]ⁿ⁻ (III.f), where n=5,
[A⁵]³⁺ [A²]⁺ [A³]⁺ [Y]ⁿ⁻ (III.g), where n=5,
[A⁷]⁴⁺ [A²]⁺ [Y]ⁿ⁻ (III.h), where n=5, and
where [A¹]²⁺, [A¹]^{+, [A}³]⁺, [A⁴]²⁺, [A⁵]³⁺, [A⁶]⁺ and [A⁷]⁴⁺ are selected independently from among the cations mentioned for [A]^{m+} and [Y]ⁿ⁻ is as defined under (A); or
   (D) mixed salts of the general formulae (IV)
[A¹]⁺ [A²]⁺ [A³]⁺ [M¹]⁺ [Y]ⁿ⁻ (IV.a), where n=4,
[A¹]⁺ [A²]⁺ [M¹]⁺ [M²]⁺ [Y]ⁿ⁻ (IV.b), where n=4,
[A¹]⁺ [M¹]⁺ [M²]⁺ [M³]⁺ [Y]ⁿ⁻ (IV.c), where n=4,
[A¹]⁺ [A²]⁺ [M¹]⁺ [Y]ⁿ⁻ (IV.d), where n=3,
[A¹]⁺ [M¹]⁺ [M²]⁺ [Y]ⁿ⁻ (IV.e), where n=3,
[A¹]⁺ [M¹]⁺ [Y]ⁿ⁻ (IV.f), where n=2,
[A¹]⁺ [A²]⁺ [M⁴]²⁺ [Y]ⁿ⁻ (IV.g), where n=4,
[A¹]⁺ [M¹]⁺ [M⁴]²⁺ [Y]ⁿ⁻ (IV.h), where n=4,
[A¹]⁺ [M⁵]³⁺ [Y]ⁿ⁻ (IV.i), where n=4,
[A¹]⁺ [M⁴]²⁺ [Y]ⁿ⁻ (IV.j), where n=3, and
   where [A¹]⁺, [A²]⁺ and [A³]⁺ are selected independently from among the cations mentioned for [A]⁺, [Y]ⁿ⁻ is as defined under (A) and [M¹]⁺, [M²]⁺, [M³]⁺ are monovalent metal cations, [M⁴]²⁺ are divalent metal cations and [M⁵]³⁺ are trivalent metal cations.

Preference is given to salts of groups (A) and (B), particularly preferably group (A). In the salts of group (A), [A]^{m+} is preferably a quaternary ammonium cation, an oxonium cation, a sulfonium cation or a phosphonium cation. It goes without saying that m is then 1.

The metal cations [M¹]⁺, [M²]⁺, [M³]⁺, [M⁴]²⁺ and [M⁵]³⁺ mentioned in the formulae (III.a) to (III.j) are generally metal cations of groups 1, 2, 3, 4, 5, 6, 7, 8, 9, 10, 11, 12, 13 and 14 of the Periodic Table. Suitable metal cations are, for example, Li⁺, Na⁺, K⁺, Cs⁺, Mg²⁺, Ca²⁺, Ba²⁺, Sc³⁺, Ti⁴⁺, Zr⁴⁺, V⁵⁺, Cr³⁺, Fe²⁺, Fe³⁺, Co²⁺, Ni²⁺, Cu²⁺, Ag⁺, Zn²⁺ and Al³⁺.

Compounds which are suitable for forming the cations [A]⁺ of ionic liquids are described, for example, in DE 102 02 838 A1. These compounds preferably comprise at least one heteroatom, e.g. from 1 to 10 heteroatoms, which are preferably selected from among nitrogen, oxygen, phosphorus and sulfur atoms. Preference is given to compounds which comprise at least one nitrogen atom and, if appropriate, additionally at least one further heteroatom other than nitrogen. Preference is given to compounds which comprise at least 1 nitrogen atom, particularly preferably from 1 to 10 nitrogen atoms, in particular from 1 to 5 nitrogen atoms, very particularly preferably from 1 to 3 nitrogen atoms and especially 1 or 2 nitrogen atoms. The last-mentioned nitrogen compounds may comprise further heteroatoms such as oxygen, sulfur or phosphorus atoms.

The positive charge of a cation of the ionic liquids can be localized on one atom in the molecule of the cation or, according to a further possibility, be partially or completely delocalized over the molecule of the cation. For example, a nitrogen atom is a suitable carrier of the positive charge in the cation of the ionic liquids. When the nitrogen atom is the carrier of the positive charge in the cation of the ionic liquids, a cation can firstly be produced by quaternization of the nitrogen atom of, for instance, an amine or a nitrogen heterocycle in the synthesis of the ionic liquids. The quaternization can be effected by protonation of the nitrogen atom. Depending on the protonating reagent used, salts having different anions are obtained. In cases in which it is not possible to form the desired anion in the quaternization, it can be formed in a further synthetic step. Starting from, for example, an ammonium halide, the halide can be reacted with a Lewis acid, forming a complex anion of halide and Lewis acid. As an alternative, a halide ion can be replaced by the desired anion. This can be achieved by addition of a metal salt with precipitation of the metal halide formed, by means of an ion exchanger or by displacement of the halide ion by a strong acid (with liberation of the hydrohalic acid). Suitable processes are described, for example, in Angew. Chem. 2000, 112, pp. 3926-3945 and the references cited therein.

Preference is given to compounds which comprise at least one five- or six-membered heterocycle, in particular a five-membered heterocycle, which has at least one nitrogen atom and optionally an oxygen or sulfur atom, with particular preference being given to compounds which comprise at leas one five- or six-membered heterocycle which has one, two or three nitrogen atoms and a sulfur or oxygen atom, particularly preferably ones having two nitrogen atoms. Further preference is given to aromatic heterocycles.

Particularly preferred compounds are those which have a molar mass of less than 1500 g/mol, very particularly preferably less than 1000 g/mol and in particular less than 800 g/mol.

The ionic liquids ILa and ILb preferably have at least one cation selected from among the compounds of the formulae (IV.a) to (IV.z),

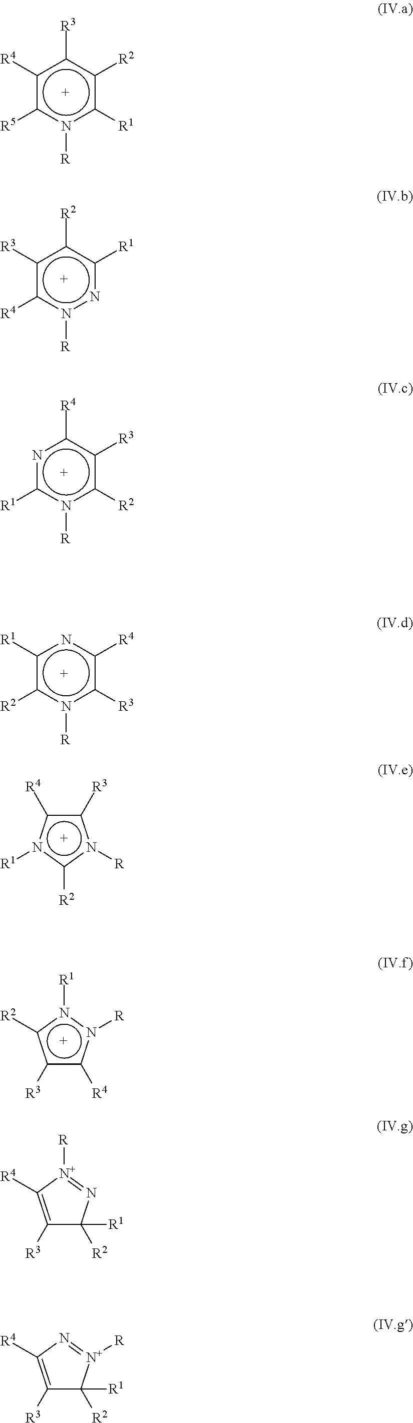

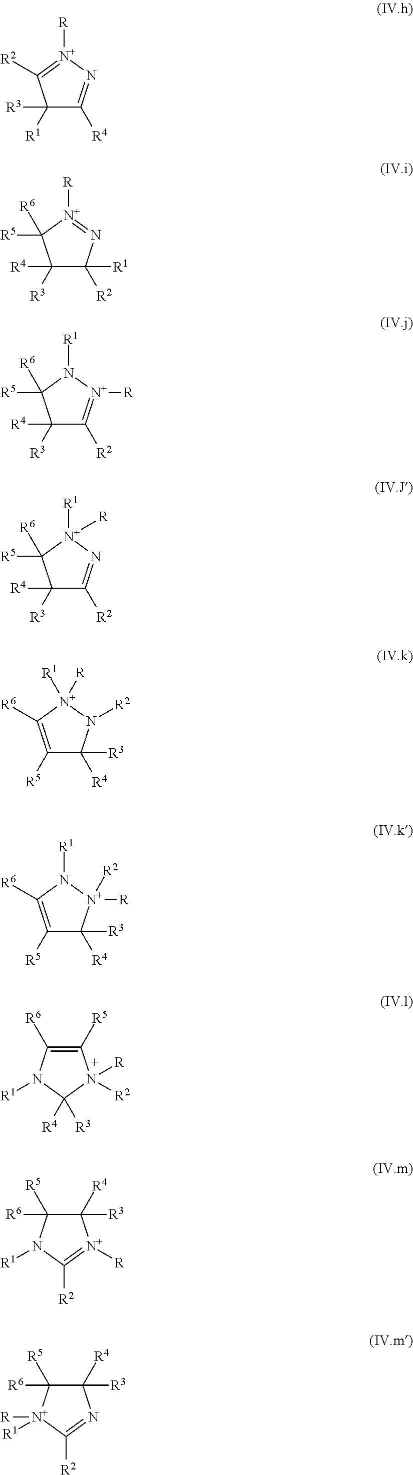

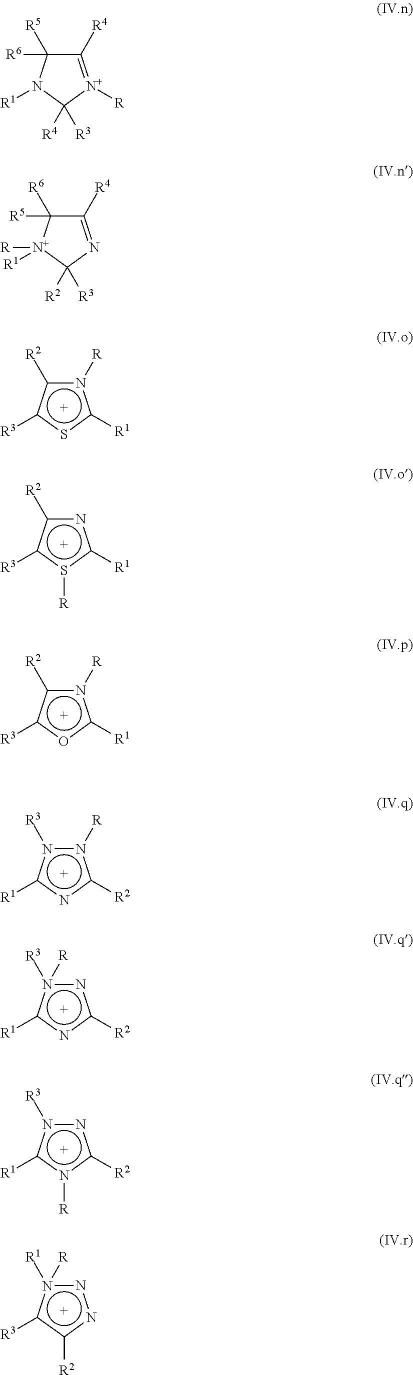

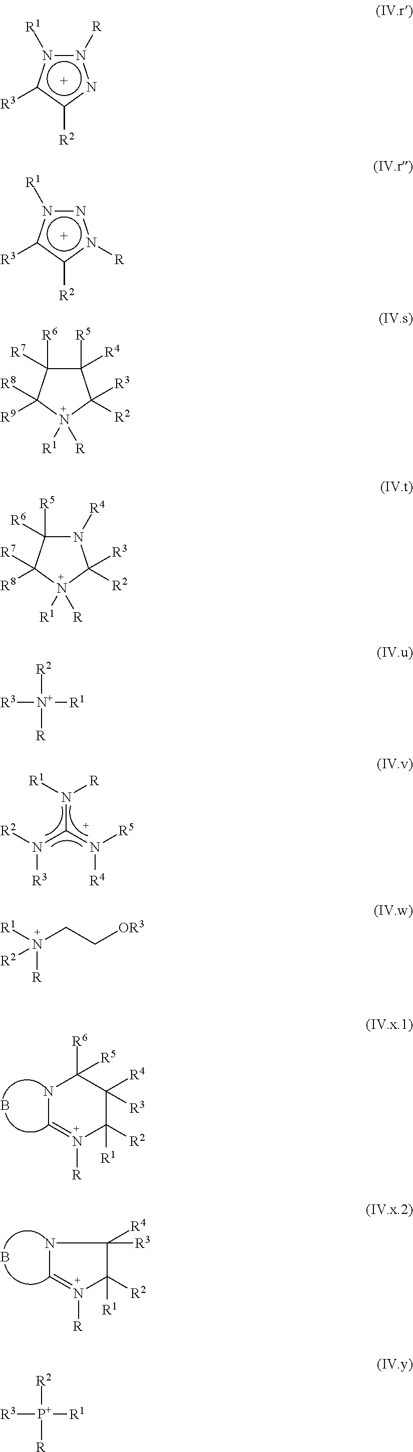

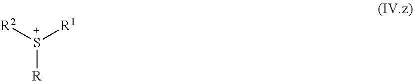

and oligomers comprising these structures, where
R is hydrogen, alkyl, alkenyl, cycloalkyl, cycloalkenyl, polycyclyl, heterocycloalkyl, aryl or heteroaryl;
radicals R¹, R², R³, R⁴, R⁵, R⁶, R⁷, R⁸ and R⁹ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy or heteroaryl, where E¹, E², E³ and E⁴ are each, independently of one another, hydrogen, alkyl, cycloalkyl, heterocycloalkyl, aryl or hetaryl,
radicals R¹, R², R³, R⁴, R⁵, R⁶, R⁷, R⁸ and R⁹ which are bound to a ring heteroatom are hydrogen, a sulfo group, NE¹E², sulfonate, alkyl, alkoxy, alkenyl, cycloalkyl, cycloalkenyl, polycyclyl, heterocycloalkyl, aryl or heteroaryl, where E¹ and E² are each, independently of one another, hydrogen, alkyl, cycloalkyl, heterocycloalkyl, aryl or hetaryl, or
two adjacent radicals R¹ to R⁹ together with the ring atoms to which they are bound may also form at least one fused-on, saturated, unsaturated or aromatic ring or a ring system having from 1 to 30 carbon atoms, where the ring or the ring system can have from 1 to 5 nonadjacent heteroatoms or heteroatom-comprising groups and the ring or the ring system can be unsubstituted or substituted,
where two geminal radicals R¹ to R⁹ may together also be ═O, ═S or ═NR^{b}, where R^{b} is hydrogen, alkyl, cycloalkyl, aryl or heteroaryl,
where R¹ and R³ or R³ and R⁵ in the compounds of the formula (IV.x.1) may together also represent the second bond of a double bond between the ring atoms bearing these radicals,
the radicals R, R¹, R², R³, R⁴, R⁵, R⁶, R⁷, R⁸ and R⁹ can alternatively be alkanediyl, cycloalkanediyl, alkenediyl or cycloalkenediyl which links a cation of one of the formulae (IV.a) to (IV.z) to a further cation of one of the formulae (IV.a) to (IV.z); where these radicals additionally function, via their second point of bonding, as radical R, R¹, R², R³, R⁴, R⁵, R⁶, R⁷, R⁸ or R⁹ of said further cation; and the radicals alkanediyl, cycloalkanediyl, alkenediyl and cycloalkenediyl mentioned can, corresponding to the above definitions of alkyl and alkenyl, be branched, substituted and/or interrupted by at least one heteroatom or heteroatom-comprising group;
B in the compounds of the formulae (IV.x.1) and (IV.x.2) together with the C—N group to which it is bound forms a 4- to 12-membered, preferably 4- to 8-membered, saturated or unsaturated or aromatic ring which may optionally be substituted and/or may optionally have further heteroatoms or heteroatom-comprising groups and/or can comprise the further fused-on saturated, unsaturated or aromatic carbocycles or heterocycles.

As regards the general meaning of the abovementioned radicals carboxylate, sulfonate, acyl, alkoxycarbonyl, halogen, NE¹E², alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy or heteroaryl, what has been said above is fully incorporated by reference at this point. Radicals R¹ to R⁹ which are bound to a carbon atom in the abovementioned formulae (IV) and have a heteroatom or heteroatom-comprising group can also be bound directly via a heteroatom to the carbon atom.

If two adjacent radicals R¹ to R⁹ together with the ring atoms to which they are bound form at least one fused-on, saturated, unsaturated or aromatic ring or a ring system having from 1 to 30 carbon atoms, where the ring or the ring system can have from 1 to 5 nonadjacent heteroatoms or heteroatom-comprising groups and the ring or the ring system may be unsubstituted or substituted, these radicals can together preferably be, as fused-on building blocks, 1,3-propylene, 1,4-butylene, 1,5-pentylene, 2-oxa-1,3-propylene, 1-oxa-1,3-propylene, 2-oxa-1,3-propylene, 1-oxa-1,3-propenylene, 3-oxa-1,5-pentylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene.

The radical R is preferably
unsubstituted C₁-C₁₈-alkyl such as methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl and 1-octadecyl;
C₁-C₁₈-alkyl substituted by one or more hydroxy, halogen, phenyl, cyano, C₁-C₆-alkoxycarbonyl and/or SO₃H groups, especially hydroxy-C₁-C₁₈-alkyl such as 2-hydroxyethyl or 6-hydroxyhexyl; phenyl-C₁-C₁₈-alkyl such as benzyl, 3-phenylpropyl; cyano-C₁-C₁₈-alkyl such as 2-cyanoethyl; C₁-C₆-alkoxy-C₁-C₁₈-alkyl such as 2-(methoxycarbonyl)ethyl, 2-(ethoxycarbonyl)ethyl or 2-(n-butoxy-carbonyl)ethyl; C₁-C₁₈-fluoroalkyl such as trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl; sulfo-C₁-C₁₈-alkyl such as 3-sulfopropyl;
hydroxyethyloxyalkyl, radicals of oligoalkylene and polyalkylene glycols such as polyethylene glycols and polypropylene glycols and oligomers thereof having from 2 to 100 units and a hydrogen or a C₁-C₈-alkyl as end group, for example R^{A}O—(CHR^{B}—CH₂—O)ₙ—CHR^{B}—CH₂— where R^{A} and R^{B} are preferably hydrogen, methyl or ethyl and n is preferably from 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxatridecyl and 3,6,9,12-tetraoxatetradecyl; and
C₂-C₆-alkenyl such as vinyl or propenyl.

The radical R is particularly preferably linear C₁-C₁₈-alkyl, for example methyl, ethyl, 1-propyl, 1-butyl, 1-pentyl, 1-hexyl, 1-heptyl, 1-octyl, 1-decyl, 1-dodecyl, 1-tetradecyl, 1-hexadecyl, 1-octadecyl, very particularly preferably methyl, ethyl, 1-butyl or 1-octyl, or CH₃O—(CH₂CH₂O)ₙ—CH₂CH₂— and CH₃CH₂O—(CH₂CH₂O)ₘ—CH₂CH₂— where m is from 0 to 3.

Preference is given to the radicals R¹ to R⁹ each being, independently of one another, hydrogen;
halogen;
a functional group selected from among hydroxy, alkoxy, alkylthio, carboxyl, —COOH, sulfonate, cyano, acyl, alkoxycarbonyl, NE¹E² and nitro, where E¹ and E² are as defined above;
C₁-C₁₈-alkyl which may be unsubstituted or substituted as defined above and/or be interrupted by at least one heteroatom or heteroatom-comprising group as defined above;
C₂-C₁₈-alkenyl which may be unsubstituted or substituted as defined above and/or interrupted by at least one heteroatom as defined above;
C₆-C₁₀-aryl which may be unsubstituted or substituted as defined above;
C₅-C₁₂-cycloalkyl which may be unsubstituted or substituted as defined above;
polycyclyl which may be unsubstituted or substituted as defined above;
C₅-C₁₂-cycloalkenyl which may be unsubstituted or substituted as defined above;
heterocycloalkyl having 5 or 6 ring atoms, where the ring has, in addition to ring carbons, 1, 2 or 3 heteroatoms or heteroatom-comprising groups selected from among oxygen, nitrogen, sulfur and NR^{a} and is unsubstituted or substituted as defined above;
heteroaryl having from 5 to 10 ring atoms, where the ring has, in addition to ring carbons, 1, 2 or 3 heteroatoms or heteroatom-comprising groups selected from oxygen, nitrogen, sulfur and NR^{a} and is unsubstituted or substituted as defined above.

Preference is likewise given to two adjacent radicals R¹ to R⁹ together with the ring atoms to which they are bound also being able to form at least one fused-on, saturated, unsaturated or aromatic ring or a ring system having from 1 to 12 carbon atoms, where the ring or the ring system can have from 1 to 5 nonadjacent heteroatoms or heteroatom-comprising groups which are preferably selected from among oxygen, nitrogen, sulfur and NR^{a} and the ring or the ring system may be unsubstituted or substituted by substituents which are preferably selected independently from among alkoxy, cycloalkyl, cycloalkoxy, polycyclyl, polycyclyloxy, heterocycloalkyl, aryl, aryloxy, arylthio, heteroaryl, halogen, hydroxy, SH, ═O, ═S, ═NR^{a}, COOH, carboxylate, —SO₃H, sulfonate, NE¹E², nitro and cyano, where E¹ and E² are each, independently of one another, hydrogen, alkyl, cycloalkyl, heterocycloalkyl, aryl or hetaryl.

When R¹ to R⁹ are alkoxy, R¹ to R⁹ are preferably methoxy or ethoxy or R^{A}O—(CH₂CH₂CH₂CH₂O)ₙ—CH₂CH₂CH₂CH₂O— where R^{A} and R^{B} are preferably hydrogen, methyl or ethyl and n is preferably from 0 to 3.

When R¹ to R⁹ are acyl, R¹ to R⁹ are preferably formyl or C₁-C₄-alkylcarbonyl, in particular formyl or acetyl.

When R¹ to R⁹ are C₁-C₁₈-alkyl, R¹ to R⁹ are preferably unsubstituted C₁-C₁₈-alkyl such as methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-9-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, heptyl, octyl, 2-ethylhexyl, 2,4,4-trimethyl-pentyl, 1,1,3,3-tetramethylbutyl, 1-nonyl, 1-decyl, 1-undecyl, 1-dodecyl, 1-tridecyl, 1-tetradecyl, 1-pentadecyl, 1-hexadecyl, 1-heptadecyl, 1-octadecyl;
C₁-C₁₈-haloalkyl, especially C₁-C₁₈-fluoroalkyl, for example trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylisopentyl, C₆F₁₃, C₈F₁₇, C₁₀F21, C₁₂F₂₅, especially C₁-C₁₈-chloroalkyl such as chloromethyl, 2-chloroethyl, trichloromethyl, 1,1-dimethyl-2-chloroethyl;
amino-C₁-C₁₈-alkyl such as 2-aminoethyl, 2-aminopropyl, 3-aminopropyl, 4-aminobutyl, 6-aminohexyl,
C₁-C₆-alkylamino-C₁-C₁₈-alkyl such as 2-methylaminoethyl, 2-methylaminopropyl, 3-methylaminopropyl, 4-methylaminobutyl, 6-methylaminohexyl;
di(C₁-C₆-alkyl)-C₁-C₁₈-alkyl such as 2-dimethylaminoethyl, 2-dimethylaminopropyl, 3-dimethylaminopropyl, 4-dimethylaminobutyl, 6-dimethylaminohexyl, cyano-C₁-C₁₈-alkyl such as 2-cyanoethyl, 2-cyanopropyl, C₁-C₁₀-alkoxy-C₁-C₁₈-alkyl such as methoxymethyl, 2-methoxyethyl, 2-methoxypropyl, 3-methoxypropyl, 2-methoxyisopropyl, 4-methoxybutyl, 6-methoxyhexyl, 2-ethoxyethyl, 2-ethoxypropyl, 3-ethoxypropyl, 4-ethoxybutyl, 6-ethoxyhexyl, 2-isopropoxyethyl, 2-butoxyethyl, 2-butoxypropyl, 2-octyloxyethyl, 5-methoxy-3-oxapentyl, 8-methoxy-3,6-dioxaoctyl, 7-methoxy-4-oxaheptyl, 11-methoxy-4,8-dioxaundecyl, 9-methoxy-5-oxanonyl, 9-methoxy-5-oxanonyl, 14-methoxy-5,10-dioxatetradecyl, 5-ethoxy-3-oxapentyl, 8-ethoxy-3,6-dioxaoctyl, 7-ethoxy-4-oxaheptyl, 11-ethoxy-4,8-dioxaundecyl, 9-ethoxy-5-oxanonyl or 14-ethoxy-5,10-oxatetradecyl, 15-methoxy-4,8,12-trioxapentadecyl, 11-methoxy-3,6,9-trioxaundecyl, 11-ethoxy-3,6,9-trioxaundecyl, 15-ethoxy-4,8,12-trioxapentadecyl;
di(C₁-C₁₀-alkoxy-C₁-C₁₈-alkyl) such as diethoxymethyl or diethoxyethyl, C₁-C₆-alkoxycarbonyl-C₁-C₁₈-alkyl such as 2-(methoxycarbonyl)ethyl, 2-(ethoxycarbonyl)ethyl, 2-(n-butoxycarbonyl)ethyl, di(C₁-C₆-alkoxycarbonyl)-C₁-C₁₈-alkyl such as 1,2-di(methoxycarbonyl)ethyl, hydroxy-C₁-C₁₅-alkyl such as 2-hydroxyethyl, 2-hydroxypropyl, 3-hydroxypropyl, 4-hydroxybutyl, 6-hydroxyhexyl, 2-hydroxy-2,2-dimethylethyl, 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-dioxatetradecyl;
C₁-C₁₂-alkylsulfanyl-C₁-C₁₈-alkyl such as butylthiomethyl, 2-dodecylthioethyl, C₅-C₁₂-cycloalkyl-C₁-C₁₈-alkyl such as cyclopentylmethyl, 2-cyclopentylethyl, 3-cyclopentylpropyl, cyclohexylmethyl, 2-cyclohexylethyl, 3-cyclohexylpropyl, phenyl-C₁-C₁₈-alkyl, where the phenyl part of phenyl-C₁-C₁₈-alkyl may be unsubstituted or be substituted by one, two, three or four substituents selected independently from among C₁-C₁₈-alkyl, halogen, C₁-C₁₈-alkoxy and nitro, e.g. benzyl (phenylmethyl), 1-phenylethyl, 2-phenylethyl, 3-phenylpropyl, p-tolylmethyl, 1-(p-butylphenyl)ethyl, p-chlorobenzyl, 2,4-dichlorobenzyl, p-methoxybenzyl, m-ethoxybenzyl, phenyl-C(CH₃)₂-, 2,6-dimethylphenylmethyl, diphenyl-C₁-C₁₈-alkyl such as diphenylmethyl (benzhydryl);
triphenyl-C₁-C₁₈-alkyl such as triphenylmethyl;
phenoxy-C₁-C₁₈-alkyl such as 2-phenoxyethyl, 2-phenoxypropyl, 3-phenoxypropyl, 4-phenoxybutyl, 6-phenoxyhexyl; phenylthio-C₁-C₁₈-alkyl such as 2-phenylthioethyl.

When R¹ to R⁹ are C₂-C₁₈-alkenyl, R¹ to R⁹ are preferably C₂-C₆-alkenyl such as vinyl, 2-propenyl, 3-butenyl, cis-2-butenyl, trans-2-butenyl or C₂-C₁₈-alkenyl which is partially fluorinated or perfluorinated.

When R¹ to R⁹ are C₆-C₁₀-aryl, R¹ to R⁹ are preferably phenyl or naphthyl, where phenyl or naphthyl may be unsubstituted or substituted by one, two, three or four substituents selected independently from among halogen, C₁-C₁₅-alkyl, C₁-C₆-alkoxy, C₁-C₆-alkylsulfanyl, C₁-C₆-alkoxy-C₁-C₆-alkyl, C₁-C₆-alkylcarbonyl, amino, C₁-C₆-alkylamino, di(C₁-C₆-alkyl)amino and nitro, e.g. phenyl, methylphenyl (tolyl), dimethylphenyl (xylyl) such as 2,6-dimethylphenyl, trimethylphenyl such as 2,4,6-trimethylphenyl, ethylphenyl, diethylphenyl, isopropylphenyl, tert-butylphenyl, dodecylphenyl, chlorophenyl, dichlorophenyl, trichlorophenyl, fluorophenyl, difluorophenyl, trifluorophenyl, tetrafluorophenyl, pentafluorophenyl, 2,6-dichlorophenyl, 4-bromophenyl, methoxyphenyl, dimethoxyphenyl, ethoxyphenyl, hexyloxyphenyl, 2,6-dimethoxyphenyl, 2-nitrophenyl, 4-nitrophenyl, 2,4-dinitrophenyl, 2,6-dinitrophenyl, 4-dimethylaminophenyl, 4-acetylphenyl, methoxyethylphenyl, ethoxymethylphenyl, methylthiophenyl, isopropylthiophenyl, tert-butylthiophenyl, α-naphthyl, β-naphthyl, methylnaphthyl, isopropylnaphthyl, chloronaphthyl, ethoxynaphthyl or partially fluorinated phenyl or perfluorinated phenyl.

When R¹ to R⁹ are C₅-C₁₂-cycloalkyl, R¹ to R⁹ are preferably unsubstituted cycloalkyl such as cyclopentyl or cyclohexyl;

C₅-C₁₂-cycloalkyl which may bear one or two substituents selected independently from among C₁-C₁₂-alkyl, C₁-C₆-alkoxy, C₁-C₆-alkylsulfanyl and chlorine, e.g. butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl;

C₅-C₁₂-cycloalkyl which is perfluorinated.

When R¹ to R⁹ are polycyclyl, R¹ to R⁹ are preferably C₅-C₁₂-bicycloalkyl such as norbornyl or C₅-C₁₂-bicycloalkenyl such as norbornenyl.

When R¹ to R⁹ are C₅-C₁₂-cycloalkenyl, R¹ to R⁹ are preferably unsubstituted cycloalkenyl such as cyclopent-2-en-1-yl, cyclopent-3-en-1-yl, cyclohex-2-en-1-yl, cyclohex-1-en-1-yl, cyclohexa-2,5-dien-1-yl or partially fluorinated or perfluorinated cycloalkenyl.

When R¹ to R⁹ are heterocycloalkyl having 5 or 6 ring atoms, R¹ to R⁹ are preferably 1,3-dioxolan-2-yl, 1,3-dioxan-2-yl, 2-methyl-1,3-dioxolan-2-yl, 4-methyl-1,3-dioxolan-2-yl.

When R¹ to R⁹ are heteroaryl, R¹ to R⁹ are preferably furyl, thienyl, pyrryl, pyridyl, indolyl, benzoxazolyl, benzimidazolyl, benzthiazolyl. In the case of substitution, hetaryl bears 1, 2 or 3 substituents which are selected independently from among C₁-C₆-alkyl, C₁-C₆-alkoxy and halogen, for example dimethylpyridyl, methylquinolyl, dimethylpyrryl, methoxyfuryl,dimethoxypyridyl or difluoropyridyl.

Particular preference is given to the radicals R¹ to R⁹ each being, independently of one another,
hydrogen;
unbranched or branched C₁-C₁₈-alkyl which may be unsubstituted or substituted by one or more hydroxy, halogen, phenyl, cyano, C₁-C₆-alkoxycarbonyl and/or sulfo groups, for example methyl, ethyl, 1-propyl, 2-propyl, 1-butyl, 2-butyl, 2-methyl-1-propyl (isobutyl), 2-methyl-2-propyl (tert-butyl), 1-pentyl, 2-pentyl, 3-pentyl, 2-methyl-1-butyl, 3-methyl-1-butyl, 2-methyl-2-butyl, 3-methyl-2-butyl, 2,2-dimethyl-1-propyl, 1-hexyl, 2-hexyl, 3-hexyl, 2-methyl-1-pentyl, 3-methyl-1-pentyl, 4-methyl-1-pentyl, 2-methyl-2-pentyl, 3-methyl-2-pentyl, 4-methyl-2-pentyl, 2-methyl-3-pentyl, 3-methyl-3-pentyl, 2,2-dimethyl-1-butyl, 2,3-dimethyl-1-butyl, 3,3-dimethyl-1-butyl, 2-ethyl-1-butyl, 2,3-dimethyl-2-butyl, 3,3-dimethyl-2-butyl, 1-heptyl, 1-octyl, 1-nonyl, 1-decyl, 1-undecyl, 1-dodecyl, 1-tetradecyl, 1-hexadecyl, 1-octadecyl, 2-hydroxyethyl, benzyl, 3-phenylpropyl, 2-cyanoethyl, methoxycarbonylmethyl, ethoxycarbonylmethyl, n-butoxycarbonylmethyl, tert-butoxycarbonylmethyl, 2-(methoxycarbonyl)ethyl, 2-(ethoxycarbonyl)ethyl, 2-(n-butoxycarbonyl)ethyl, trifluoromethyl, difluoromethyl, fluoromethyl, pentafluoroethyl, heptafluoropropyl, heptafluoroisopropyl, nonafluorobutyl, nonafluoroisobutyl, undecylfluoropentyl, undecylfluoroisopentyl, 6-hydroxyhexyl and 3-sulfopropyl;
hydroxyethyloxyalkyl, radicals of oligoalkylene and polyalkylene glycols such as polyethylene glycols and polypropylene glycols and oligomers thereof having from 2 to 100 units and a hydrogen or a C₁-C₈-alkyl as end group, for example R^{A}O—(CHR^{B}—CH₂—O)ₙ—CHR^{B}—CH₂— or R^{A}O—(CH₂CH₂CH₂CH₂O)ₙ—CH₂CH₂CH₂CH₂O— where R^{A} and R^{B} are preferably hydrogen, methyl or ethyl and n is preferably from 0 to 3, in particular 3-oxabutyl, 3-oxapentyl, 3,6-dioxaheptyl, 3,6-dioxaoctyl, 3,6,9-trioxadecyl, 3,6,9-trioxaundecyl, 3,6,9,12-tetraoxatridecyl and 3,6,9,12-tetraoxatetradecyl;
C₂-C₄-alkenyl such as vinyl or allyl; and
N,N-di-C₁-C₆-alkylamino such as N,N-dimethylamino and N,N-diethylamino.

Very particular preference is given to the radicals R¹ to R⁹ each being, independently of one another, hydrogen; C₁-C₁₈-alkyl such as methyl, ethyl, 1-butyl, 1-pentyl, 1-hexyl, 1-heptyl, 1-octyl; phenyl; 2-hydroxyethyl; 2-cyanoethyl; 2-(alkoxycarbonyl)ethyl such as 2-(methoxycarbonyl)ethyl, 2-(ethoxycarbonyl)ethyl or 2-(n-butoxycarbonyl)ethyl; N,N-(C₁-C₄-dialkyl)amino such as N,N-dimethylamino or N,N-diethylamino; chlorine or radicals of oligoalkylene glycol, e.g. CH₃O—(CH₂CH₂O)ₙ—CH₂CH₂— or CH₃CH₂O—(CH₂CH₂O)ₙ—CH₂CH₂— where n is from 0 to 3.

Very particularly preferred pyridinium ions (IVa) are those in which
one of the radicals R¹ to R⁵ is methyl, ethyl or chlorine and the remaining radicals R¹ to R⁵ are each hydrogen;
R³ is dimethylamino and the remaining radicals R¹, R², R⁴ and R⁵ are each hydrogen;
all radicals R¹ to R⁵ are hydrogen;
R² is carboxy or carboxamide and the remaining radicals R¹, R², R⁴ and R⁵ are each hydrogen; or
R¹ and R² or R² and R³ together are 1,4-buta-1,3-dienylene and the remaining radicals R¹, R², R⁴ and R⁵ are each hydrogen;
   in particular those in which
R¹ to R⁵ are each hydrogen; or
one of the radicals R¹ to R⁵ is methyl or ethyl and the remaining radicals R¹ to R⁵ are each hydrogen.

As pyridinium ions (IVa), particular preference is given to pyridinium, 2-methylpyridinium, 2-ethylpyridinium, 5-ethyl-2-methylpyridinium and 2-methyl-3-ethylpyridinium and 1-methylpyridinium, 1-ethylpyridinium, 1-(1-butyl)pyridinium, 1-(1-hexyppyridinium, 1-(1-octyl)pyridinium, 1-(1-howl)pyridinium, 1-(1-octyl)pyridinium, 1-(1-dodecyl)pyridinium, 1-(1-tetradecyl)pyridinium, t-(1-hexadecyl)pyridinium, 1,2-dimethylpyridinium, 1-ethyl-2-methylpyridinium, 1-(1-butyl)-2-methylpyridinium, 1-(1-hexyl)-2-methylpyridinium, 1-(1-octyl)-2-methylpyridinium, 1-(1-dodecyl)-2-methyl-pyridinium, 1-(1-tetradecyl)-2-methylpyridinium, 1-(1-hexadecyl)-2-methylpyridinium, 1-methyl-2-ethylpyridinium, 1,2-diethylpyridinium, 1-(1-butyl)-2-ethylpyridinium, 1-(1-hexyl)-2-ethylpyridinium, 1-(1-octyl)-2-ethylpyridinium, 1-(1-dodecyl)-2-ethylpyridinium, 9-(1-tetradecyl)-2-ethylpyridinium, 1-(1-hexadecyl)-2-ethylpyridinium, 1,2-dimethyl-5-ethylpyridinium, 1,5-diethyl-2-methylpyridinium, 1-(1-butyl)-2-methyl-3-ethylpyridinium, 1-(1-hexyl)-2-methyl-3-ethylpyridinium and 1-(1-octyl)-2-methyl-3-ethyl-pyridinium, 1-(1-dodecyl)-2-methyl-3-ethylpyridinium, 1-(1-tetradecyl)-2-methyl-3-ethyl-pyridinium and 1-(1-hexadecyl)-2-methyl-3-ethylpyridinium.

Particularly preferred pyridazinium ions (IVb) are those in which
the radicals R¹ to R⁴ are each hydrogen, or
one of the radicals R¹ to R⁴ is methyl or ethyl and the remaining radicals R¹ to R⁴ are each hydrogen.

Particularly preferred pyrimidinium ions (IVc) are those in which
R¹ is hydrogen, methyl or ethyl and R² to R⁴ are each, independently of one another, hydrogen or methyl or
R¹ is hydrogen, methyl or ethyl and R² and R⁴ are each methyl and R³ is hydrogen.

Particularly preferred pyrazinium ions (IVd) are those in which
R¹ is hydrogen, methyl or ethyl and R² to R⁴ are each, independently of one another, hydrogen or methyl or
R¹ is hydrogen, methyl or ethyl and R² and R⁴ are each methyl and R³ is hydrogen or
R¹ to R⁴ are each methyl or
R¹ to R⁴ are each hydrogen.

Particularly preferred imidazolium ions (IVe) are those in which
R¹ is hydrogen, methyl, ethyl, 1-propyl, 1-butyl, 1-pentyl, 1-hexyl, 1-octyl, 2-hydroxyethyl or 2-cyanoethyl and R² to R⁴ are each, independently of one another, hydrogen, methyl or ethyl.

Particularly useful imidazolium ions (IVe) are 1-methylimidazolium, 1-ethylimidazolium, 1-(1-propyl)imidazolium, 1-(1-allyl)imidazolium, 1-(1-butyl)imidazolium, 1-(1-octyl)-imidazolium, 1-(1-dodecyl)imidazolium, 1-(1-tetradecyl)imidazolium, 1-(1-hexadecyl)-imidazolium, 1,3-dimethylimidazolium, 1,3-diethylimidazolium, 1-ethyl-3-methylimidazolium, 1-(1-butyl)-3-methylimidazolium, 1-(1-butyl)-3-ethylimidazolium, 1-(1-hexyl)-3-methylimidazolium, 1-(1-hexyl)-3-ethylimidazolium, 1-(1-hexyl)-3-butyl-imidazolium, 1-(1-octyl)-3-methylimidazolium, 1-(1-octyl)-3-ethylimidazolium, 1-(1-octyl)-3-butylimidazolium, 1-(1-dodecyl)-3-methylimidazolium, 1-(1-dodecyl)-3-ethylimidazolium, 1-(1-dodecyl)-3-butylimidazolium, 1-(1-dodecyl)-3-octylimidazolium, 1-(1-tetradecyl)-3-methylimidazolium, 1-(1-tetradecyl)-3-ethylimidazolium, 1-(1-tetradecyl)-3-butylimidazolium, 1-(1-tetradecyl)-3-octylimidazolium, 1-(1-hexadecyl)-3-methylimidazolium, 1-(1-hexadecyl)-3-ethylimidazolium, 1-(1-hexadecyl)-3-butylimidazolium, 1-(1-hexadecyl)-3-octylimidazolium, 1,2-dimethylimidazolium, 1,2,3-trimethylimidazolium, 1-ethyl-2,3-dimethylimidazolium, 1-(1-butyl)-2,3-dimethylimidazolium, 1-(1-hexyl)-2,3-dimethylimidazolium, 1-(1-octyl)-2,3-dimethylimidazolium, 1,4-dimethylimidazolium, 1,3,4-trimethylimidazolium, 1,4-dimethyl-3-ethylimidazolium, 1,4-dimethyl-3-octylimidazolium, 1,4,5-trimethylimidazolium, 1,3,4,5-tetramethylimidazolium, 1,4,5-trimethyl-3-ethylimidazolium, 1,4,5-trimethyl-3-butylimidazolium, 1,4,5-trimethyl-3-octylimidazolium, 1-prop-1-en-3-yl-3-methylimidazolium and 1-prop-1-en-3-yl-3-butylimidazolium.

Particularly preferred pyrazolium ions (IVf), (IVg) and (IVg′) are those in which R¹ is hydrogen, methyl or ethyl and R² to R⁴ are each, independently of one another, hydrogen or methyl.

Particularly preferred pyrazolium ions (IVh) are those in which R¹ to R⁴ are each, independently of one another, hydrogen or methyl.

As pyrazolium ions, particular preference is given to 1,4-dimethylpyrazolium and 1,2,4-trimethylpyrazolium.

1-Pyrazolinium ions (IVi) used in the process of the invention are particularly preferably those in which R¹ to R⁶ are each, independently of one another, hydrogen or methyl.

Particularly preferred 2-pyrazolinium ions (IVj) and (IVj′) are those in which R¹ is hydrogen, methyl, ethyl or phenyl and R² to R⁶ are each, independently of one another, hydrogen or methyl.

Particularly preferred 3-pyrazolinium ions (IVk) and (IVk′) are those in which R¹ and R² are each, independently of one another, hydrogen, methyl, ethyl or phenyl and R³ to R⁶ are each, independently of one another, hydrogen or methyl.

Particularly preferred imidazolinium ions (IVl) are those in which R¹ and R² are each, independently of one another, hydrogen, methyl, ethyl, 1-propyl, 1-butyl, 1-hexyl or phenyl and R³ and R⁴ are each, independently of one another, hydrogen, methyl or ethyl and R⁵ and R⁶ are each, independently of one another, hydrogen or methyl.

Particularly preferred imidazolinium ions (IVm) and (IVm′) are those in which R¹ and R² are each, independently of one another, hydrogen, methyl, ethyl, 1-propyl, 1-butyl or 1-hexyl and R³ to R⁶ are each, independently of one another, hydrogen or methyl.

Particularly preferred imidazolinium ions (IVn) and (IVn′) are those in which R¹ to R³ are each, independently of one another, hydrogen, methyl or ethyl and R⁴ to R⁶ are each, independently of one another, hydrogen or methyl.

Particularly preferred thiazolium ions (IVo) and (IVo′) and oxazolium ions (IVp) are those in which R¹ is hydrogen, methyl, ethyl or phenyl and R² and R³ are each, independently of one another, hydrogen or methyl.

Particularly preferred 1,2,4-triazolium ions (IVq), (IVq′) and (IVq″) are those in which R¹ and R² are each, independently of one another, hydrogen, methyl, ethyl or phenyl and R³ is hydrogen, methyl or phenyl.

Particularly preferred 1,2,3-triazolium ions (IVr), (IVr′) and (IVr″) are those in which R¹ is hydrogen, methyl or ethyl, R² and R³ are each, independently of one another, hydrogen or methyl or R² and R³ together are 1,4-buta-1,3-dienylene.

Particularly preferred pyrrolidinium ions (IVs) are those in which R¹ is hydrogen, methyl, ethyl or phenyl and R² to R⁹ are each, independently of one another, hydrogen or methyl.

Particularly preferred imidazolidinium ions (IVt) are those in which R¹ and R⁴ are each, independently of one another, hydrogen, methyl, ethyl, 1-propyl, 1-butyl, 1-hexyl or phenyl and R², R³ and R⁵ to R⁸ are each, independently of one another, hydrogen or methyl.

Particularly preferred ammonium ions (IVu) are those in which
R¹ to R³ are each, independently of one another, C₁-C₁₈-alkyl or
R¹ and R² together are 1,5-pentylene or 3-oxa-1,5-pentylene and R³ is selected from among C₁-C₁₈-alkyl, 2-hydroxyethyl and 2-cyanoethyl.

Examples of tertiary amines from which the quaternary ammonium ions of the general formula (IVu) can be derived by quaternization with the abovementioned radical R are diethyl-n-butylamine, diethyl-tert-butylamine, diethyl-n-pentylamine, diethylhexylamine, diethyloctylamine, diethyl(2-ethylhexyl)amine, di-n-propylbutylamine, di-n-propyl-n-pentylamine, di-n-propylhexylamine, di-n-propyloctylamine, di-n-propyl(2-ethylhexyl)-amine, diisopropylethylamine, diisopropyl-n-propylamine, diisopropylbutylamine, diisopropylpentylamine, diisopropylhexylamine, diisopropyloctylamine, diisopropyl(2-ethylhexyl)amine, di-n-butylethylamine, di-n-butyl-n-propylamine, di-n-butyl-n-pentylamine, di-n-butylhexylamine, di-n-butyloctylamine, di-n-butyl(2-ethylhexyl)amine, N-n-butylpyrrolidine, N-sec-butylpyrrolidine, N-tert-butylpyrrolidine, N-n-pentylpyrrolidine, N,N-dimethylcyclohexylamine, N,N-diethylcyclohexylamine, N,N-di-n-butylcyclohexylamine, N-n-propylpiperidine, N-isopropylpiperidine, N-n-butylpiperidine, N-sec-butylpiperidine, N-tert-butylpiperidine, N-n-pentylpiperidine, N-n-butylmorpholine, N-sec-butylmorpholine, N-tert-butylmorpholine, N-n-pentyl-morpholine, N-benzyl-N-ethylaniline, N-benzyl-N-n-propylaniline, N-benzyl-N-isopropyl-aniline, N-benzyl-N-n-butylaniline, N,N-dimethyl-p-toluidine, N,N-diethyl-p-toluidine, N,N-di-n-butyl-p-toluidine, diethylbenzylamine, di-n-propylbenzylamine, di-n-butyl-benzylamine, diethylphenylamine, di-n-propylphenylamine and di-n-butylphenylamine.

Preferred tertiary amines (IVu) are diisopropylethylamine, diethyl-tert-butylamine, diisopropylbutylamine, di-n-butyl-n-pentylamine, N,N-di-n-butylcyclohexylamine and also tertiary amines derived from pentyl isomers.

Particularly preferred tertiary amines are di-n-butyl-n-pentylamine and tertiary amines derived from pentyl isomers. A further preferred tertiary amine which has three identical radicals is triallylamine.

Particularly preparation guanidinium ions (IVv) are those in which
R¹ to R⁵ are each methyl. A very particularly preferred guanidinium ion (IVv) is N,N,N′,N′,N″,N″-hexamethylguanidinium.

Particularly preferred cholinium ions (IVw) are those in which
R¹ and R² are each independently of one another, methyl, ethyl, 1-butyl or 1-octyl and R³ is hydrogen, methyl, ethyl, acetyl, —SO₂OH or —PO(OH)₂ or
R¹ is methyl, ethyl, 1-butyl or 1-octyl, R² is a —CH₂—CH₂—OR⁴ group and R³ and R⁴ are each, independently of one another, hydrogen, methyl, ethyl, acetyl, —SO₂OH or —PO(OH)2 or
R¹ is a —CH₂—CH₂—OR⁴ group, R² is a —CH₂—CH₂—OR⁵ group and R³ to R⁵ are each, independently of one another, hydrogen, methyl, ethyl, acetyl, —SO₂OH or —PO(OH)₂.

As cholinium ions (IVw), particular preference is given to those in which R³ is selected from among hydrogen, methyl, ethyl, acetyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxanonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

The cations (IV.x.1) are particularly preferably selected from among cations of 1,5-diazabicyclo[4.3.0]non-5-ene (DBN) and 1,8-diazabicyclo[5.4.0]-undec-7-ene (DBU).

Particularly preferred phosphonium ions (IVy) are those in which
R¹ to R³ are each, independently of one another, C₁-C₁₈-alkyl, in particular butyl, isobutyl, 1-hexyl or 1-octyl, or phenyl which may be unsubstituted or substituted by 1, 2, 3, 4 or 5 substituents selected independently from among C₁-C₁₈-alkyl, carboxylate, sulfonate, COOH and SO₃H.

Particularly preferred sulfonium ions (IVz) are those in which
R¹ and R² are each, independently of one another, C₁-C₁₈-alkyl, in particular butyl, isobutyl, 1-hexyl or 1-octyl.

Among the abovementioned heterocyclic cations, preference is given to the imidazolium ions, imidazolinium ions, pyridinium ions, pyrazolinium ions and pyrazolium ions. Particular preference is given to the imidazolium ions and also cations of DBU and DBN.

In an embodiment of the invention, the cations of the ionic liquids ILa and ILb are selected from among pyridinium ions of the formula (IV.a), imidazolium ions of the formula (IV.e), pyrazolium ions of the formulae (IV.f), (IV.g), (IV.g′) and (IV.h) and also ammonium ions of the formulae (IV.u) and (IV.w).

In a preferred embodiment of the invention, the cations of the ionic liquids ILa and ILb are selected from among pyridinium ions of the formula (IV.a), imidazolium ions of the formula (IV.e), pyrazolium ions of the formula (IV.f) and ammonium ions of the formula (IV.u), where the radicals R, R¹, R², R³, R⁴ and R⁵ are each, independently of one another, preferably hydrogen, alkyl, cycloalkyl or aryl.

In a particularly preferred embodiment of the invention, the cations of the ionic liquids ILa and ILb are selected from among imidazolium ions of the formula (IV.e) and ammonium ions of the formula (IV.u), where the radicals R, R¹, R² and R³ which are bound to a nitrogen atom are each, independently of one another, C₁-C₆-alkyl and the radicals R², R³ and R⁴ which are bound to a carbon atom are each hydrogen.

The anion [Y]ⁿ⁻ of the ionic liquids ILa and ILb is, for example, selected from:
the group of halides, pseudohalides and halogen- and pseudohalogen-comprising compounds of the formulae:
F—, Cl—, Br—, I—, BF₄—, PF₆—, CF₃SO₃—, (CF₃SO₃)₂N—, (NC)₂N—, CF₃CO₂—, CCl₃CO₂—, CN—, SCN—, OCN—;
the group of sulfates, sulfites and sulfonates of the general formulae:
SO₄²—, HSO₄—, SO₃²—, HSO₃—, R^{c}OSO₃—, R^{c}SO₃—;
the group of phosphates of the general formulae:
PO₄³—, HPO₄²—, H₂PO₄—, R^{c}PO₄²—, HR^{c}PO₄—, R^{c}R^{d}PO₄—;
the group of phosphonates and phosphinates of the general formulae:
R^{c}HPO₃—, R^{c}R^{d}PO₂—, R^{c}R^{d}PO₃—;
the group of phosphites of the general formulae:
PO₃³—, HPO₃²—, H₂PO₃—, R^{c}PO₃²—, R^{c}HPO₃—, R^{c}R^{d}PO₃—;
the group of phosphonites and phosphinites of the general formulae:
R^{c}R^{d}PO₂—, R^{c}HPO₂—, R^{c}R^{d}PO—, R^{c}HPO—;
the group of carboxylates of the general formula:
R^{c}COO—;
anions of hydroxycarboxylic acids and sugar acids;
saccharinates (salts of o-benzosulfimide);
the group of borates of the general formulae:
BO₃³—, HBO₃²—, H₂BO₃—, R^{c}R^{d}BO₃—, R^{c}HBO₃—, R^{c}BO₃²—, B(OR^{c})(OR^{d})(OR^{e})(OR^{f})—, B(HSO₄)₄—, B(R^{c}SO₄)₄—;
the group of boronates of the general formulae:
R_{c}BO₂²—, R^{c}R^{d}BO—;
the group of carbonates and carbonic esters of the general formulae:
HCO₃—, CO₃²—, R^{c}CO₃—;
the group of silicates and silicic esters of the general formulae:
SiO₄⁴—, HSiO₄³—, H₂SiO₄²—, H₃SiO₄—, R^{c}SiO₄³—, R^{c}R^{d}SiO₄²—, R^{c}R^{d}R^{e}SiO₄—, HR^{c}SiO₄²—, H₂R^{c}SiO₄—, HR^{c}R^{d}SiO₄—;
the group of alkylsilanolates and arylsilanolates of the general formulae:
R^{c}SiO₃³—, R^{c}R^{d}SiO₂²—, R^{c}R^{d}R^{e}SiO—, R^{c}R^{d}R^{e}SiO₃—, R^{c}R^{d}R^{e}SiO₂—, R^{c}R^{d}SiO₃²—;
the group of carboximides, bis(sulfonyl)imides and sulfonylimides of the general formulae:

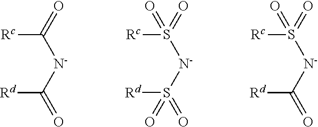

the group of methides of the general formula:

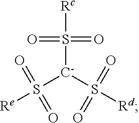

the group of alkoxides and aryloxides of the general formula R^{c}O—;
the group of hydrogensulfides, polysulfides, hydrogenpolysulfides and thiolates of the general formulae:
HS—, [Sᵥ]²—, [HSᵥ]—, [R^{c}S]—, where v is a positive integer from 2 to 10.

Preference is given to the radicals R^{c}, R^{d}, R^{e} and R^{f} each being, independently of one another,
hydrogen;
alkyl, preferably C₁-C₃₀-alkyl, particularly preferably C₁-C₁₈-alkyl, which may unsubstituted or substituted as defined above and/or be interrupted by at least one heteroatom or heteroatom-comprising group as defined above;
aryl, preferably C₆-C₁₄-aryl, particularly preferably C₆-C₁₀-aryl which may be unsubstituted or substituted as defined above;
cycloalkyl, preferably C₅-C₁₂-cycloalkyl which may be unsubstituted or substituted as defined above;
heterocycloalkyl, preferably heterocycloalkyl having 5 or 6 ring atoms, where the ring has, apart from ring carbons, 1, 2 or 3 heteroatoms or heteroatom-comprising groups, which may be unsubstituted or substituted as defined above;
heteroaryl, preferably heteroaryl having from 5 to 10 ring atoms, where the ring has, apart from ring carbons, 1, 2 or 3 heteroatoms or heteroatom-comprising groups selected from among oxygen, nitrogen, sulfur and NR^{a}, which may be unsubstituted or substituted as defined above;
where, in anions which have a plurality of radicals R^{c} to R^{f}, two of these radicals together with the part of the anion to which they are bound can also form at least one saturated, unsaturated or aromatic ring or a ring system having from 1 to 12 carbon atoms, where the ring or the ring system can have from 1 to 5 nonadjacent heteroatoms or heteroatom-comprising groups which are preferably selected from among oxygen, nitrogen, sulfur and NR^{a}, and the ring or the ring system may be unsubstituted or substituted.

As regards suitable and preferred C₁-C₃₀-alkyls, in particular C₁-C₁₈-alkyls, C₆-C₁₄-aryls, in particular C₆-C₁₀-aryls, C₅-C₁₂-cycloalkyls, heterocycloalkyls having 5 or 6 ring atoms and heteroaryls having 5 or 6 ring atoms, what has been said above is incorporated by reference at the present point. As regards suitable and preferred substituents on C₁-C₃₀-alkyl, especially C₁-C₁₈-alkyl, C₆-C₁₂-aryl, C₅-C₁₂-cycloalkyl, heterocycloalkyl having 5 or 6 ring atoms and heteroaryl having 5 or 6 ring atoms, what has been said above in respect of substituents is likewise incorporated by reference at the present point.

When at least one of the radicals R^{c} to R^{f} is optionally substituted C₁-C₁₈-alkyl, it is preferably methyl, ethyl, propyl, isopropyl, n-butyl, sec-butyl, tert-butyl, pentyl, hexyl, heptyl, octyl, 2-ethylhexyl, 2,4,4-trimethylpentyl, decyl, dodecyl, tetradecyl, hexadecyl, octadecyl, 1,1-dimethylpropyl, 1,1-dimethylbutyl, 1,1,3,3-tetramethylbutyl, benzyl, 1-phenylethyl, α,α-dimethylbenzyl, benzhydryl, p-tolylmethyl, 1-(p-butylphenyl)ethyl, p-chlorobenzyl, 2,4-dichlorobenzyl, p-methoxybenzyl, m-ethoxybenzyl, 2-cyanoethyl, 2-cyanopropyl, 2-methoxycarbonylethyl, 2-ethoxycarbonylethyl, 2-butoxycarbonyl-propyl, 1,2-di(methoxycarbonyl)ethyl, 2-methoxyethyl, 2-ethoxyethyl, 2-butoxyethyl, diethoxymethyl, diethoxyethyl, 1,3-dioxolan-2-yl, 1,3-dioxan-2-yl, 2-methyl-1,3-dioxolan-2-yl, 4-methyl-1,3-dioxolan-2-yl, 2-isopropoxyethyl, 2-butoxypropyl, 2-octyloxyethyl, chloromethyl, trichloromethyl, perfluorinated C₁-C₁₀-alkyl, of which trifluoromethyl is an example, 1,1-dimethyl-2-chloroethyl, 2-methoxy-isopropyl, 2-ethoxyethyl, butylthiomethyl, 2-dodecylthioethyl, 2-phenylthioethyl, 2,2,2-trifluoroethyl, 2-hydroxyethyl, 2-hydroxypropyl, 3-hydroxypropyl, 4-hydroxybutyl, 6-hydroxyhexyl, 2-aminoethyl, 2-aminopropyl, 4-aminobutyl, 6-aminohexyl, 2-methylaminoethyl, 2-methylaminopropyl, 3-methylaminopropyl, 4-methylaminobutyl, 6-methylaminohexyl, 2-dimethylaminoethyl, 2-dimethylaminopropyl, 3-dimethylaminopropyl, 4-dimethylaminobutyl, 6-dimethylaminohexyl, 2-hydroxy-2,2-dimethylethyl, 2-phenoxyethyl, 2-phenoxypropyl, 3-phenoxypropyl, 4-phenoxybutyl, 6-phenoxyhexyl, 2-methoxyethyl, 2-methoxypropyl, 3-methoxypropyl, 4-methoxybutyl, 6-methoxyhexyl, 2-ethoxyethyl, 2-ethoxypropyl, 3-ethoxypropyl, 4-ethoxybutyl or 6-ethoxyhexyl.

When at least one of the radicals R^{c} to R^{f} is C₁-C₁₈-alkyl interrupted by one or more nonadjacent heteroatoms or heteroatom-comprising groups, it is preferably 5-hydroxy-3-oxapentyl, 8-hydroxy-3,6-dioxaoctyl, 11-hydroxy-3,6,9-trioxaundecyl, 7-hydroxy-4-oxaheptyl, 11-hydroxy-4,8-dioxaundecyl, 15-hydroxy-4,8,12-trioxapentadecyl, 9-hydroxy-5-oxanonyl, 14-hydroxy-5,10-oxatetradecyl, 5-methoxy-3-oxapentyl, 8-methoxy-3,6-dioxaoctyl, 11-methoxy-3,6,9-trioxaundecyl, 7-methoxy-4-oxaheptyl, 11-methoxy-4,8-dioxaundecyl, 15-methoxy-4,8,12-trioxapentadecyl, 9-methoxy-5-oxa-nonyl, 14-methoxy-5,10-oxatetradecyl, 5-ethoxy-3-oxapentyl, 8-ethoxy-3,6-dioxaoctyl, 11-ethoxy-3,6,9-trioxaundecyl, 7-ethoxy-4-oxaheptyl, 11-ethoxy-4,8-dioxaundecyl, 15-ethoxy-4,8,12-trioxapentadecyl, 9-ethoxy-5-oxanonyl or 14-ethoxy-5,10-oxatetradecyl.

If two radicals R^{c} to R^{f} form a ring, these radicals can together be, for example, a fused-on 1,3-propylene, 1,4-butylene, 2-oxa-1,3-propylene, 1-oxa-1,3-propylene, 2-oxa-1,3-propenylene, 1-aza-1,3-propenylene, 1-C₁-C₄-alkyl-1-aza-1,3-propenylene, 1,4-buta-1,3-dienylene, 1-aza-1,4-buta-1,3-dienylene or 2-aza-1,4-buta-1,3-dienylene building block.

The number of nonadjacent heteroatoms or heteroatom-comprising groups in the radicals R^{c} to R^{f} is in principle not critical and is generally restricted only by the size of the respective radical or ring building block. In general, there will be no more than 5 in the respective radical, particularly preferably no more than 4 and very particularly preferably no more than 3. Furthermore, there will generally be at least one carbon atom, preferably at least two carbon atoms, between each two heteroatoms.

Substituted and unsubstituted imino groups can be, for example, imino, methylimino, isopropylimino, n-butylimino or tert-butylimino.

Preferred functional groups of the radicals R^{c} to R^{f} are carboxy, carboxamide, hydroxy, di(C₁-C₄-alkyl)amino, C₁-C₄-alkyloxycarbonyl, cyano or C₁-C₄-alkoxy. In addition, radicals R^{c} to R^{f} which are not alkyl can be substituted by one or more C₁-C₄-alkyl groups, preferably methyl, ethyl, propyl, isopropyl, n-butyl, sec-butyl or tert-butyl.

When at least one of the radicals R^{c} to R^{f} is optionally substituted C₆-C₁₀-aryl, it is preferably phenyl, methylphenyl (tolyl), xylyl, α-naphthyl, β-naphthyl, chlorophenyl, dichlorophenyl, trichlorophenyl, difluorophenyl, dimethylphenyl, trimethylphenyl, ethylphenyl, diethylphenyl, isopropylphenyl, tert-butylphenyl, dodecylphenyl, methoxyphenyl, dimethoxyphenyl, ethoxyphenyl, hexyloxyphenyl, methylnaphthyl, isopropylnaphthyl, chloronaphthyl, ethoxynaphthyl, 2,6-dimethylphenyl, 2,4,6-trimethyl-phenyl, 2,6-dimethoxyphenyl, 2,6-dichlorophenyl, 4-bromophenyl, 2- or 4-nitrophenyl, 2,4- or 2,6-dinitrophenyl, 4-dimethylaminophenyl, 4-acetylphenyl, methoxyethylphenyl or ethoxymethylphenyl.

When at least one of the radicals R^{c} to R^{f} is optionally substituted C₅-C₁₂-cycloalkyl, it is preferably cyclopentyl, cyclohexyl, cyclooctyl, cyclododecyl, methylcyclopentyl, dimethylcyclopentyl, methylcyclohexyl, dimethylcyclohexyl, diethylcyclohexyl, butylcyclohexyl, methoxycyclohexyl, dimethoxycyclohexyl, diethoxycyclohexyl, butylthiocyclohexyl, chlorocyclohexyl, dichlorocyclohexyl, dichlorocyclopentyl or a saturated or unsaturated bicyclic system such as norbornyl or norbornenyl.

When at least one of the radicals R^{c} to R^{f} is an optionally substituted five- or six-membered heterocycle, it is preferably furyl, thienyl, pyrryl, pyridyl, indolyl, benzoxazolyl, dioxolyl, dioxyl, benzimidazolyl, benzthiazolyl, dimethylpyridyl, methylquinolyl, dimethylpyryl, methoxyfuryl, dimethoxypyridyl, difluoropyridyl, methylthiophenyl, isopropylthiophenyl or tert-butylthiophenyl.

When, in anions which have a plurality of radicals R^{c} to R^{f}, two of these radicals together with the part of the anion to which they are bound each also form at least one saturated, unsaturated or aromatic ring or a ring system having from 1 to 12 carbon atoms, where the ring or the ring system can have from 1 to 5 nonadjacent heteroatoms or heteroatom-comprising groups which are preferably selected from among oxygen, nitrogen, sulfur and NR^{a}, then the ring or the ring system is unsubstituted or bears 1, 2, 3, 4, 5 or more than 5 substituents. The substituents are preferably selected independently from among alkyl, alkoxy, alkylsulfanyl, cycloalkyl, cycloalkoxy, polycyclyl, heterocycloalkyl, aryl, aryloxy, arylthio and heteroaryl.

In a preferred embodiment of the invention, the anion of the at least one hydrophilic ionic liquid ILa is selected from among:
F—, Cl—, B—, I—, BF₄—, PF₆—, (NC)₂N—, CF₃CO₂—, CCl₃CO₂—, CN—, SCN— and OCN—;
sulfates, sulfites and sulfonates of the general formulae SO₄²—, HSO₄—, SO₃²—, HSO₃—, R^{c}OSO₃— and R^{c}SO₃—;
phosphates of the general formulae PO₄³—, HPO₄²—, H₂PO₄—, R^{c}PO₄²—, HR^{c}PO₄— and R^{c}R^{d}PO₄—;
phosphonates and phosphinates of the general formulae R^{c}HPO₃—, R^{c}R^{d}PO₂— and R^{c}R^{d}PO₃—;
Phosphites of the general formulae PO₃³—, HPO₃²—, H₂PO₃—, R^{c}PO₃²—, R^{c}HPO₃— and R^{c}R^{d}PO₃—;
phosphonites and phosphinites of the general formulae R^{c}R^{d}PO₂—, R^{c}HPO₂—, R^{c}R^{d}PO— and R^{c}HPO—;
carboxylates of the general formula R^{c}COO—;
anions of hydroxycarboxylic acids and sugar acids;
carbonates and carbonic esters of the general formulae HCO₃—, CO₃²— and R^{c}CO₃—
   where the radicals R^{c}, R^{d}, R^{e} and R^{f} are as defined above.

In a particularly preferred embodiment of the invention, the anion of the at least one hydrophilic ionic liquid ILa is selected from among:
F—, Cl—, Br—, I—, BF₄—, PF₆—, (NC)₂N—, SCN—, OCN—;
sulfates and sulfonates of the general formulae R^{c}OSO₃— and R^{c}SO₃—;
phosphates of the general formulae R^{c}PO₄²—, HR^{c}PO₄— and R^{c}R^{d}PO₄—;
carboxylates of the general formula R^{c}COO—;
carbonates and carbonic esters of the general formulae HCO₃—, CO₃²— and R_{c}CO₃—
   where the radicals R^{c} and R^{d} are as defined above.

In a particularly preferred embodiment of the invention, the anion of the at least one hydrophilic ionic liquid ILa is selected from among:

R^{c}OSO₃—, R^{c}SO₃— and R^{c}COO—;

where Rc is hydrogen, C₁-C₄-alkyl or C₃-C₇-cycloalkyl.

In a further preferred embodiment of the invention, the anion of the at least one hydrophobic ionic liquid ILb is selected from among:
carboxylates of the general formula R^{c1}COO—, where R^{c1} is C₅-C₂₆-alkyl;
sulfates and sulfonates of the general formulae R^{c2}OSO₃— and R^{c2}SO₃—, phosphates of the general formulae R^{c2}PO₄²—, HR^{c2}PO₄— and R^{c2}R^{d2}PO₄— and also carbonates of the general formula R^{c2}CO₃—, where R^{c2} is perfluorinated C₁-C₁₀-alkyl and R^{d2} is perfluorinated C₁-C₁₀-alkyl or C₅-C₂₆-alkyl;
bis(sulfonyl)imides and sulfonylimides of the general formulae:

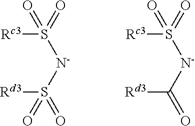

where the radicals R^{c3} and R^{d3} are each, independently of one another, fluorine, C₅-C₂₆-alkyl or perfluorinated C₁-C₁₀-alkyl; or together are optionally perfluorinated C₁-C₄-alkanediyl (alkylene).

In a further particularly preferred embodiment of the invention, the anion of the at least one hydrophobic ionic liquid ILb is selected from among:

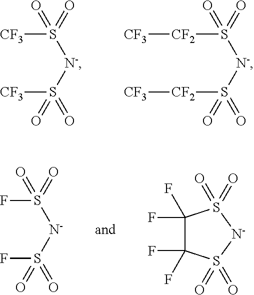

Cations and anions are present in the ionic liquid. Within the ionic liquid, a proton or an alkyl radical is transferred from the cation to the anion. This results in two uncharged molecules. An equilibrium in which anions, cations and the two uncharged molecules formed therefrom is thus present.

In general, the proportions of the at least one ionic liquid ILa and the at least one ionic liquid ILB are each in the range from 0.1 to 99.9% by weight, preferably each in the range from 1 to 99% by weight and in particular each in the range from 4 to 96% by weight, based on the total weight of the mixtures according to the invention of ionic liquids. The abovementioned proportions refer, when more than one ionic liquid ILa or more than one ionic liquid ILb is/are used, in each case to the sum of the proportions of all ionic liquids ILa or all ionic liquids ILb, respectively.

The ionic liquids ILa and ILb of the mixtures of the invention are advantageously completely miscible with one another under use conditions, i.e. a homogeneous liquid is formed by mixing the ionic liquid(s) ILa with the ionic liquid(s) ILb.

In general, the viscosity of the inventive mixtures of at least one hydrophilic ionic liquid ILa and at least one hydrophobic ionic liquid at temperatures of from 20 to 100° C. is in the range from 1 to 1000 mPa·s, preferably in the range from 10 to 200 mP·s and particularly preferably in the range from 50 to 150 mPa·s.

The invention further provides for the use of mixtures according to the invention of ionic liquids ILa and ILb as operating liquid for producing the liquid ring in a liquid ring compressor.

The invention further provides a method of operating a liquid ring compressor, wherein a mixture according to the invention of ionic liquids ILa and ILb is used as operating liquid. Such a method is preferably used for generating a vacuum below 20 mbar.

The method of the invention for operation of a liquid ring compressor relates, in particular, to a liquid ring compressor having an impeller installed eccentrically in a compressor housing with gas being fed to the liquid ring compressor on a suction side and gas being discharged on a pressure side, wherein the method comprises the following steps:
production of a liquid ring on the inside of the compressor housing by rotation of an impeller arranged eccentrically in the housing,
sucking-in of gas into chambers formed between blades of the impeller and the liquid ring,
compression of the gas in the chambers which become smaller from the suction side to the pressure side as a result of the rotation and the eccentric arrangement of the impeller and
expulsion of the compressed gas on the suction side.

When used as operating liquid in liquid ring compressors for generating a vacuum, the inventive mixtures of ionic liquids are distinguished from conventional operating liquids particularly in that they very largely suppress cavitation. They therefore also allow, in particular, the evacuation of gases which comprise cavitation-promoting components such as water without cavitation phenomena such as an appreciable drop in performance of the compressor and the associated deterioration in the vacuum or noise pollution and damage to the compressor occurring. In contrast to conventional operating liquids, the mixtures according to the invention of ionic liquids therefore also suffer from little deterioration in performance when they are used for the evacuation of, for example, gases laden with water. They therefore also have to be replaced, worked up again and/or disposed of very much more rarely. Overall, the mixtures of ionic liquids of the invention therefore lead to a reduced maintenance requirement and to improved and constant performance of liquid ring compressors.

The present invention is illustrated below with the aid of nonlimiting examples.

### EXAMPLES

### Example 1

The water content of a mixture of 15 g of 1-ethyl-3-methylimidazolium acetate (EMIM acetate) and 5 g of 1-(1-propyl)-3-methylimidazolium bis(trifluorosulfonyl)imide (PMIM TFSI) (weight ratio 75:25) was set to a value of 1.1% by weight by addition of water. The mixture was stirred under a vacuum of 5 mbar for 5 hours. An unchanged water content of 1.1% by weight was then measured.

### Example 2

The water content of a mixture of 9.5 g of 1-ethyl-3-methylimidazolium acetate (EMIM acetate) and 0.5 g of 1-(1-propyl)-3-methylimidazolium bis(trifluorosulfonyl)imide (PMIM TFSI) (weight ratio 95:5) was set to a value of 1.0% by weight by addition of water. The mixture was stirred under a vacuum of 5 mbar for 5 hours. An unchanged water content of 1.0% by weight was then measured.

### Example 3

The water content of a mixture of 9.5 g of 1-ethyl-3-methylimidazolium acetate (EMIM acetate) and 0.5 g of 1-(1-propyl)-3-methylimidazolium bis(trifluorosulfonyl)imide (PMIM TFSI) (weight ratio 95:5) was set to a value of 1.1% by weight by addition of water. The mixture was stirred under a vacuum of 5 mbar for 5 hours. An unchanged water content of 1.1% by weight was then measured.

Examples 1 to 3 show that relatively small amounts of water cannot be removed from the mixtures according to the invention of ionic liquids even when they are subjected to a very low vacuum of 5 mbar for a number of hours. Accordingly, any aqueous impurities comprised in the mixtures of the invention used as operating liquid are not liberated by vaporization under the operating conditions of liquid ring compressors. The mixtures according to the invention therefore suppress cavitation even when they are contaminated with relatively large amounts of water, for example as a result of continued use for the evacuation of gases comprising water vapor.

1. A method of operating a liquid ring compressor, wherein a mixture of ionic liquids comprising
at least one ionic liquid ILa which is completely miscible with water at 20° C. and 1013 mbar and
at least one ionic liquid ILb which has a miscibility gap with water at 20° C. and 1013 mbar
is an operating liquid for producing the liquid ring.

2. The method according to claim 1, wherein the ionic liquids ILa and ILb are selected from among
(A) salts of the general formula (I)
[A]ₚ^{m+} [Y]_{q}ⁿ⁻ (I),
where:
m, n, p and q are each 1, 2, 3 or 4 and the product of p and m is equal to the product of q and n;
[A]^{m+} is a monovalent, divalent, trivalent or tetravalent cation or a cationic compound comprising two or more cationic groups which are preferably selected independently from among ammonium groups, oxonium groups, sulfonium groups and phosphonium groups; and
[Y]ⁿ⁻ is a monovalent, divalent, trivalent or tetravalent anion or a mixture of these anions;
(B) mixed salts of the general formulae (II.a), (II.b) or (II.c)
[A¹]⁺ [A²]⁺ [Y]ⁿ⁻ (II.a), where n=2,
[A¹]⁺ [A²]⁺ [A³]⁺ [Y]ⁿ⁻ (II.b), where n=3,
[A¹]⁺ [A²]⁺ [A³]⁺ [A⁴]⁺ [Y]ⁿ⁻ (II.C), where n=4, and
where [A¹]⁺, [A²]⁺, [A³]⁺ and [A⁴]⁺ are selected independently from among the monovalent cations mentioned for [A]^{m+} and [Y]ⁿ⁻ is as defined under (A); or
(C) mixed salts of the general formulae (III.a) to (III.h)
[A¹]²⁺ [A²]⁺ [Y]ⁿ⁻ (III.a), where n=3,
[A¹]²⁺ [A²]⁺ [A³]⁺ [Y]ⁿ⁻ (III.b), where n=4,
[A¹]²⁺ [A⁴]²⁺ [Y]ⁿ⁻ (III.c), where n=4,
[A⁵]³⁺ [A²]⁺ [Y]ⁿ⁻ (III.d), where n=4,
[A¹]²⁺ [A²]⁺ [A³]⁺ [A⁶]⁺ [Y]ⁿ⁻ (III.e), where n=5,
[A¹]²⁺ [A⁴]²⁺ [A⁶]⁺ [Y]ⁿ⁻ (III.f), where n=5,
[A⁵]³⁺ [A²]⁺ [A³]⁺ [Y]ⁿ⁻ (III.g), where n=5,
[A⁷]⁴⁺ [A²]⁺ [Y]ⁿ⁻ (III.h), where n=5, and
where [A¹]²⁺, [A²]⁺, [A³]⁺, [A⁴]²⁺, [A⁵]³⁺, [A⁶]⁺ and [A⁷]⁴⁺ are selected independently from among the cations mentioned for [A]^{m+} and [Y]ⁿ⁻ is as defined under (A); or
(D) mixed salts of the general formulae (IV.a) to (IV.j)
[A¹]⁺ [A²]⁺ [A³]⁺ [M¹]⁺ [Y]ⁿ⁻ (IV.a), where n=4,
[A¹]⁺ [A²]⁺ [M¹]⁺ [M²]⁺ [Y]ⁿ⁻ (IV.b), where n=4,
[A¹]⁺ [M¹]⁺ [M²]⁺ [M³]⁺ [Y]ⁿ⁻ (IV.c), where n=4,
[A¹]⁺ [A²]⁺ [M¹]⁺ [Y]ⁿ⁻ (IV.d), where n=3,
[A¹]⁺ [M¹]⁺ [M²]⁺ [Y]ⁿ⁻ (IV.e), where n=3,
[A¹]⁺ [M¹]⁺ [Y]ⁿ⁻ (IV.f), where n=2,
[A¹]⁺ [A²]⁺ [M⁴]²⁺ [Y]ⁿ⁻ (IV.g), where n=4,
[A¹]⁺ [M¹]⁺ [M⁴]²⁺ [Y]ⁿ⁻ (IV.h), where n=4,
[A¹]⁺ [M⁵]³⁺ [Y]ⁿ⁻ (IV.i), where n=4,
[A¹]⁺ [M⁴]²⁺ [Y]ⁿ⁻ (IV.j), where n=3, and
where [A¹]⁺, [A²]⁺ and [A³]⁺ are selected independently from among the cations mentioned for [A]⁺, [Y]ⁿ⁻ is as defined under (A) and [M¹]⁺, [M²]⁺, [M³]⁺ are monovalent metal cations, [M⁴]²⁺ are divalent metal cations and [M⁵]³⁺ are trivalent metal cations.

3. The method according to claim 1, wherein the cations of the ionic liquids ILa and ILb are selected from the group of compounds of the formulae (IV.a) to (IV.z), 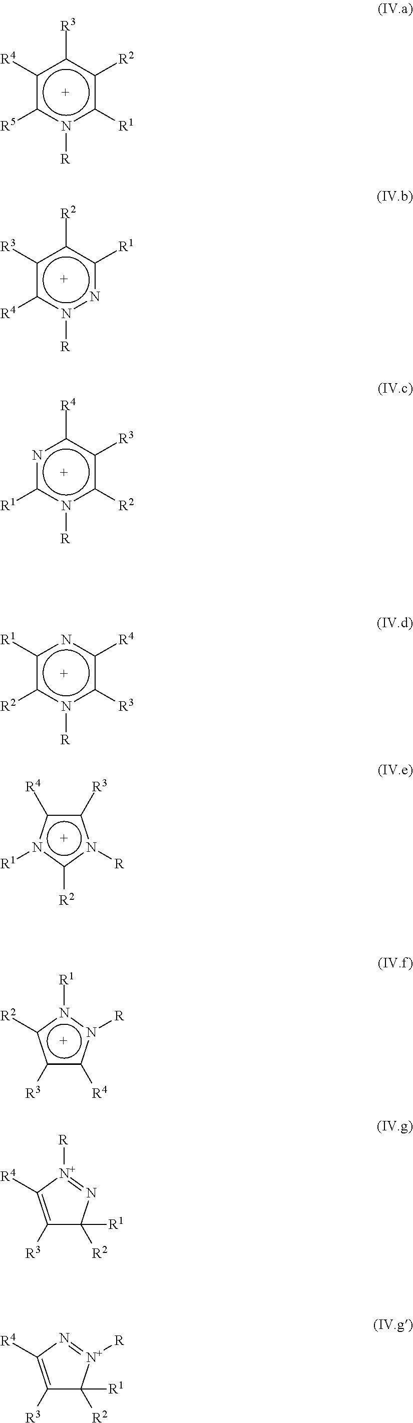 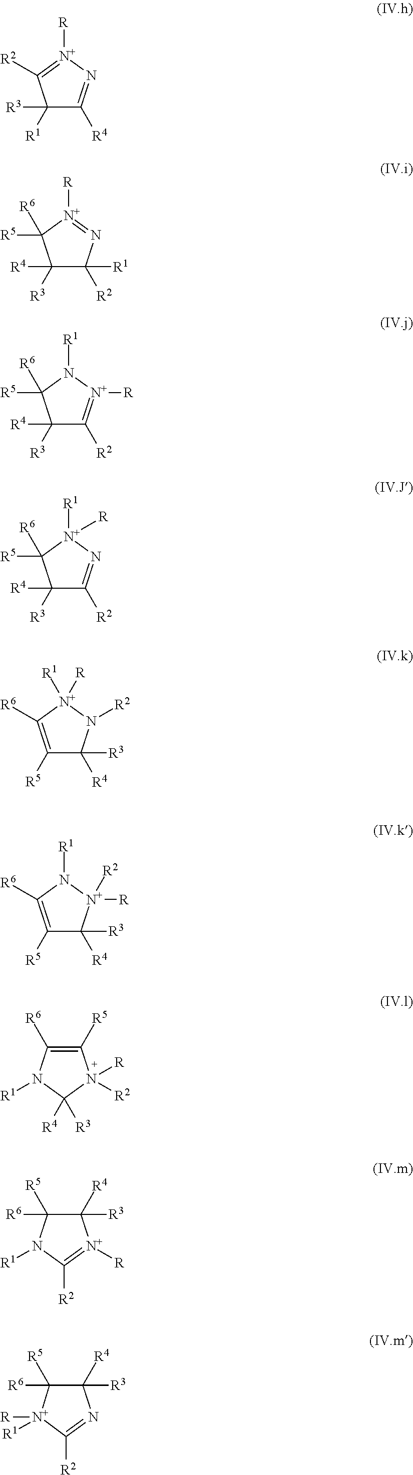 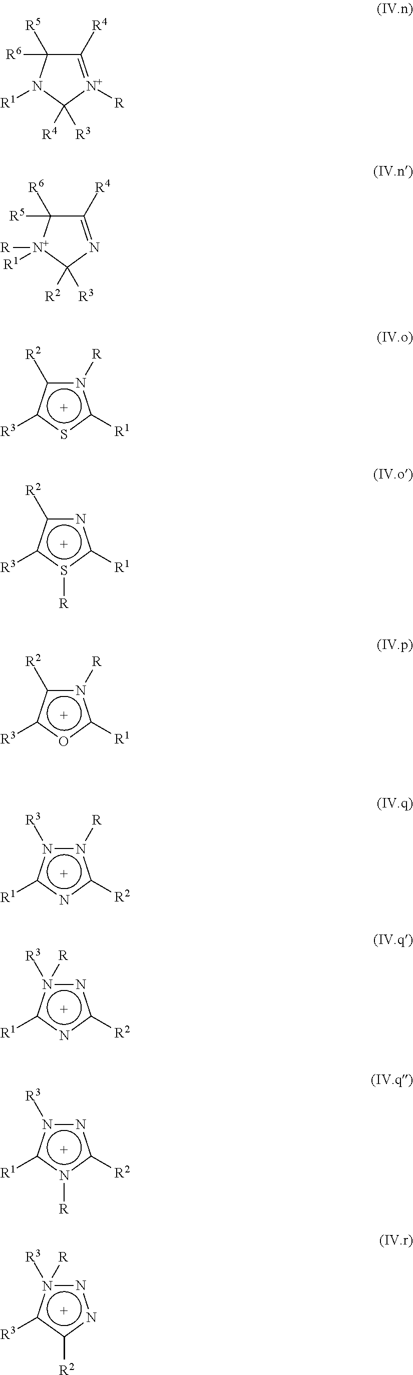 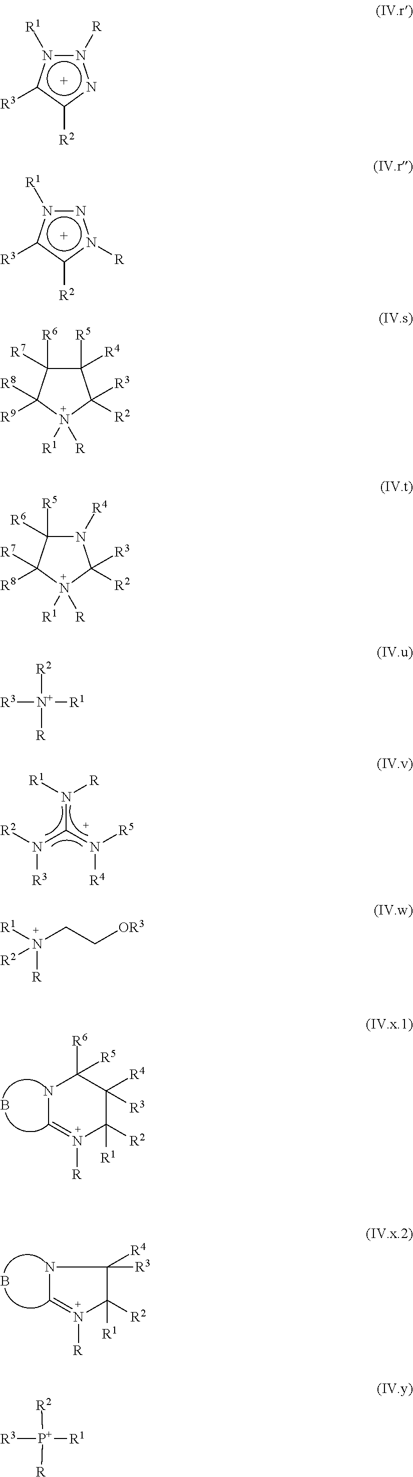 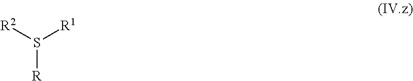
and oligomers comprising these structures, where
R is hydrogen, alkyl, alkenyl, cycloalkyl, cycloalkenyl, polycyclyl, heterocycloalkyl, aryl or heteroaryl;
radicals R¹, R², R³, R⁴, R⁵, R⁶, R⁷, R⁸ and R⁹ which are bound to a ring carbon are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy or heteroaryl, where E¹, E², E³ and E⁴ are each, independently of one another, hydrogen, alkyl, cycloalkyl, heterocycloalkyl, aryl or hetaryl,
radicals R¹, R², R³, R⁴, R⁵, R⁶, R⁷, R⁸ and R⁹ which are bound to a ring heteroatom are hydrogen, a sulfo group, NE¹E², sulfonate, alkyl, alkoxy, alkenyl, cycloalkyl, cycloalkenyl, polycyclyl, heterocycloalkyl, aryl or heteroaryl, where E¹ and E² are each, independently of one another, hydrogen, alkyl, cycloalkyl, heterocycloalkyl, aryl or hetaryl,
or
two adjacent radicals R¹ to R⁹ together with the ring atoms to which they are bound may also form at least one fused-on, saturated, unsaturated or aromatic ring or a ring system having from 1 to 30 carbon atoms, where the ring or the ring system can have from 1 to 5 nonadjacent heteroatoms or heteroatom-comprising groups and the ring or the ring system can be unsubstituted or substituted,
where two geminal radicals R¹ to R⁹ may together also be ═O, ═S or ═NR^{b}, where R^{b} is hydrogen, alkyl, cycloalkyl, aryl or heteroaryl,
and
R¹ and R³ or R³ and R⁵ in the compounds of the formula (IV.x.1) may together also represent the second bond of a double bond between the ring atoms bearing these radicals or,
the radicals R, R¹, R², R³, R⁴, R⁵, R⁶, R⁷, R⁸ and R⁹ can alternatively be alkanediyl, cycloalkanediyl, alkenediyl or cycloalkenediyl which links a cation of one of the formulae (IV.a) to (IV.z) to a further cation of one of the formulae (IV.a) to (IV.z); where these radicals additionally function, via their second point of bonding, as radical R, R¹, R², R³, R⁴, R⁵, R⁶, R⁷, R⁸ or R⁹ of said further cation; and the radicals alkanediyl, cycloalkanediyl, alkenediyl and cycloalkenediyl mentioned can be branched, substituted and/or interrupted by at least one heteroatom or heteroatom-comprising group;
B in the compounds of the formulae (IV.x.1) and (IV.x.2) together with the C—N group to which it is bound forms a 4- to 8-membered saturated or unsaturated or aromatic ring which may optionally be substituted and/or may optionally have further heteroatoms or heteroatom-comprising groups and/or can comprise the further fused-on saturated, unsaturated or aromatic carbocycles or heterocycles.

4. The method according to claim 3, wherein the cations of the ionic liquids ILa and ILb are selected from among compounds of the formulae (IV.a), (IV.e), (IV.f), (IV.g), (IV.g′), (IV.h), (IV.u) and (IV.w).

5. The method according to claim 4, wherein the cations of the ionic liquids ILa and ILb are selected from among compounds of the formulae (IV.a), (IV.e), (IV.f) and (IV.u).

6. The method according to claim 5, wherein the radicals R, R¹, R², R³, R⁴ and R⁵ of the compounds of the formulae (IV.a), (IV.e), (IV.f) and (IV.u) are each, independently of one another, hydrogen, alkyl, cycloalkyl or acyl.

7. The method according to claim 6, wherein the cations of the ionic liquids ILa and ILb are selected from among compounds of the formulae (IV.e) and (IV.u) in which radicals R, R¹, R² and R³ which are bound to a nitrogen atom are each, independently of one another, C₁-C₆-alkyl and the radicals R², R³ and R⁴ which are bound to a carbon atom are each hydrogen.

8. The method according to claim 3, wherein the anions of the ionic liquids ILa and ILb are different from one another.

9. The method according to claim 8, wherein the cations of the ionic liquids ILa and ILb are identical.

10. The method according to claim 1, wherein the anions of the ionic liquids ILa and ILb are selected from among anions of:
the group of halides, pseudohalides and halogen- and pseudohalogen-comprising compounds of the formulae:
F—, Cl—, Br—, I—, BF₄—, PF₆—, CF₃SO₃—, (CF₃SO₃)₂N—, (NC)₂N—, CF₃CO₂—, CCl₃CO₂—, CN—, SCN—, OCN—;
the group of sulfates, sulfites and sulfonates of the general formulae:
SO₄²—, HSO₄—, SO₃²—, HSO₃—, R^{c}OSO₃—, R^{c}SO₃—;
the group of phosphates of the general formulae:
PO₄³—, HPO₄²—, H₂PO₄—, R^{c}PO₄²—, HR^{c}PO₄—, R^{c}R^{d}PO₄ —;
the group of phosphonates and phosphinates of the general formulae:
R^{c}HPO₃—, R^{c}R^{d}PO₂—, R^{c}R^{d}PO₃—;
the group of phosphites of the general formulae:
PO₃³—, HPO₃²—, H₂PO₃—, R^{c}PO₃²—, R^{c}HPO₃—, R^{c}R^{d}PO₃—;
the group of phosphonites and phosphinites of the general formulae:
R^{c}R^{d}PO₂—, R^{c}HPO₂—, R^{c}R^{d}PO—, R^{c}HPO—;
the group of carboxylates of the general formula:
R^{c}COO—;
anions of hydroxycarboxylic acids and sugar acids;
saccharinates (salts of o-benzosulfimide);
the group of borates of the general formulae:
BO₃³—, HBO₃²—, H₂BO₃—, R^{c}R^{d}BO₃—, R^{c}BO₃—, R^{c}BO₃²—, B(OR^{c})(OR^{d})(OR^{e})(OR^{f})—, B(HSO₄)₄—, B(R^{c}SO₄)₄—;
the group of boronates of the general formulae:
R^{c}BO₂²—, R^{c}R^{d}BO—;
the group of carbonates and carbonic esters of the general formulae:
HCO₃—, CO₃²—, R^{c}CO₃—;
the group of silicates and silicic esters of the general formulae:
SiO₄⁴—, HSiO₄³—, H₂SiO₄²—, H₃SiO₄—, R^{c}SiO₄³—, R^{c}R^{d}SiO₄²—, R^{c}R^{d}R^{e}SiO₄—, HR^{c}SiO₄²—, H₂R^{c}SiO₄—, HR^{c}R^{d}SiO₄—;
the group of alkylsilanolates and arylsilanolates of the general formulae:
R^{c}SiO₃³—, R^{c}R^{d}SiO₂²—, R^{c}R^{d}R^{e}SiO—, R^{c}R^{d}R^{e}SiO₃—, R^{c}R^{d}R^{e}SiO₂—, R^{c}R^{d}SiO₃²—;
the group of carboximides, bis(sulfonyl)imides and sulfonylimides of the general formulae: 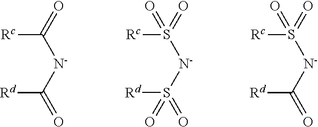
the group of methides of the general formula: 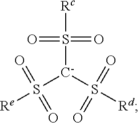
the group of alkoxides and aryloxides of the general formula R^{c}O—;
the group of hydrogensulfides, polysulfides, hydrogenpolysulfides and thiolates of the general formulae:
HS—, [Sᵥ]²—, [HSᵥ]—, [R^{c}S]—, where v is a positive integer from 2 to 10;
where the radicals R^{c}, R^{d}, R^{e} and R^{f} are selected independently from among hydrogen, alkyl, cycloalkyl, heterocycloalkyl, aryl and heteroaryl and in the case of carboximides, bis(sulfonyl)imides, sulfonylimides and methides additionally fluoride,
where, in anions which have a plurality of radicals R^{c} to R^{f}, two of these radicals together with the part of the anion to which they are bound can each form at least one saturated, unsaturated or aromatic ring or a ring system having from 1 to 12 carbon atoms, where the ring or the ring system can have from 1 to 5 nonadjacent heteroatoms or heteroatom-comprising groups which are preferably selected from among oxygen, nitrogen, sulfur and NR^{a}, and the ring or the ring system may be unsubstituted or substituted, where R^{a} is hydrogen, alkyl, cycloalkyl, heterocycloalkyl, aryl or heteroaryl.

11. The method according to claim 10, wherein the anions of the at least one ionic liquid ILa are selected from among anions of:
the group of halides, pseudohalides and halogen- and pseudohalogen-comprising compounds of the formulae:
F—, Cl—, Br—, I—, BF₄—, PF₆—, (NC)₂N—, CF₃CO₂—, CCl₃CO₂—, CN—, SCN—, OCN—;
the group of sulfates, sulfites and sulfonates of the general formulae:
SO₄²—, HSO₄—, SO₃²—, HSO₃—, R^{c}OSO₃—, R^{c}SO₃—;
the group of phosphates of the general formulae:
PO₄³—, HPO₄²—, H₂PO₄—, R^{c}PO₄²—, HR^{c}PO⁴—, R^{c}R^{d}PO₄—;
the group of phosphonates and phosphinates of the general formulae:
R^{c}HPO₃—, R^{c}R^{d}PO₂—, R^{c}R^{d}PO₃—;
the group of phosphites of the general formulae:
PO₃³—, HPO₃²—, H₂PO₃—, R^{c}PO₃²—, R^{c}HPO₃—, R^{c}R^{d}PO₃—;
the group of phosphonites and phosphinites of the general formulae:
R^{c}R^{d}PO₂—, R^{c}HPO₂—, R^{c}R^{d}PO—, R^{c}HPO—;
the group of carboxylates of the general formula:
R^{c}COO—;
anions of hydroxycarboxylic acids and sugar acids;
the group of carbonates and carbonic esters of the general formulae:
HCO₃—, CO₃²—, R^{c}CO₃—;
where the radicals R^{c}, R^{d}, R^{e} and R^{f} are as defined above.

12. The method according to claim 11, wherein the anions of the at least one ionic liquid ILa are selected from among anions of:
the group of halides, pseudohalides and halogen- and pseudohalogen-comprising compounds of the formulae:
F—, Cl—, Br—, I—, BF₄—, PF₆—, (NC)₂N—, SCN—, OCN—;
the group of sulfates, sulfonates and phosphates of the general formulae:
R^{c}OSO₃—, R^{c}SO₃—, R^{c}PO₄²—, HR^{c}PO₄—, R^{c}R^{d}PO₄—;
the group of carboxylates of the general formula:
R^{c}COO—;
the group of carbonates and carbonic esters of the general formulae:
HCO₃—, CO₃²—, R^{c}CO₃—;
where the radicals R^{c} and R^{d} are as defined above.

13. The method according to claim 12, wherein the anions of the at least one ionic liquid ILa are selected from among sulfates, sulfonates and carboxylates of the general formulae:
R^{c}OSO₃—, R^{c}SO₃— and R^{c}COO—;
where R^{c} is hydrogen, C₁-C₄-alkyl or C₃-C₇-cycloalkyl.

14. The method according to claim 10, wherein the anions of the at least one ionic liquid ILb are selected from among anions of:
the group of carboxylates of the general formula:
R^{c1}COO—, where R^{c1} is C₅-C₂₆-alkyl;
the group of sulfates, phosphates, carbonates, and sulfonates of the general formulae:
R^{c2}OSO₃—, R^{c2}SO₃—, R^{c2}PO₄²—, HR^{c2}PO₄—, R^{c2}R^{d2}PO₄—, R^{c2}CO₃—,
where R^{c2} is perfluorinated C₁-C₁₀-alkyl and R^{d2} is perfluorinated C₁-C₁₀-alkyl or C₅-C₂₆-alkyl;
the group of bis(sulfonyl)imides and sulfonylimides of the general formulae: 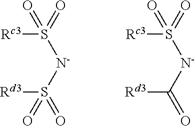
where the radicals R^{c3} and R^{d3} are each, independently of one another, fluorine, C₅-C₂₆-alkyl or perfluorinated C₁-C₁₀-alkyl; or together are optionally perfluorinated C₁-C₄-alkanediyl.

15. The method according to claim 14, wherein the anions of the at least one ionic liquid ILb are selected from among the anions:

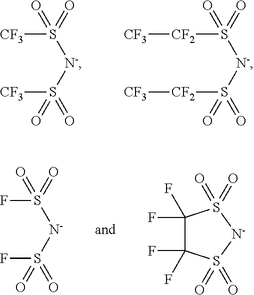

16. The method according to claim 1, which comprises:
from 0.1 to 99.9% by weight of at least one ionic liquid ILa and
from 0.1 to 99.9% by weight of at least one ionic liquid ILb, based on the total weight of ILa and ILb.

17. The method according to claim 16, which comprises:
from 4 to 96% by weight of at least one ionic liquid ILa and
from 4 to 96% by weight of at least one ionic liquid ILb, based on the total weight of ILa and ILb.

18. The method according to claim 1, wherein the viscosity of the mixture at temperatures of from 20 to 100° C. is in the range from 1 to 1000 mPa·s.

19. The method of operating a liquid ring compressor to claim 1, for generating a vacuum below 20 mbar.

20. A mixture of ionic liquids comprising
at least one ionic liquid ILa which is completely miscible with water at 20° C. and 1013 mbar and
at least one ionic liquid ILb which has a miscibility gap with water at 20° C. and 1013 mbar;
wherein the cations of the ionic liquids ILa and ILb are selected from among compounds of the formula (IV.e) 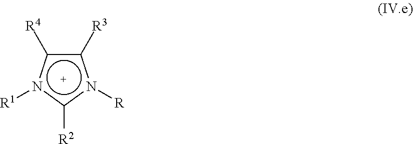
and oligomers comprising these structures, where
R is hydrogen, alkyl, alkenyl, cycloalkyl, cycloalkenyl, polycyclyl, heterocycloalkyl, aryl or heteroaryl,
radicals R¹, R², R³ and R⁴ which are bound to a ring carbon atom are each, independently of one another, hydrogen, a sulfo group, COOH, carboxylate, sulfonate, acyl, alkoxycarbonyl, CO(NE¹E²), cyano, halogen, hydroxyl, SH, nitro, NE³E⁴, alkyl, alkoxy, alkylthio, alkylsulfinyl, alkylsulfonyl, alkenyl, cycloalkyl, cycloalkyloxy, cycloalkenyl, cycloalkenyloxy, polycyclyl, polycyclyloxy, heterocycloalkyl, aryl, aryloxy or heteroaryl, where E¹, E², E³ and E⁴ are each, independently of one another, hydrogen, alkyl, cycloalkyl, heterocycloalkyl, aryl or hetaryl,
the radical R¹ which is bound to a ring heteroatom is hydrogen, a sulfo group, NE¹E², sulfonate, alkyl, alkoxy, alkenyl, cycloalkyl, cycloalkenyl, polycyclyl, heterocycloalkyl, aryl or heteroaryl, where E¹ and E² are each, independently of one another, hydrogen, alkyl, cycloalkyl, heterocycloalkyl, aryl or hetaryl, or
two adjacent radicals R¹ to R⁴ together with the ring atoms to which they are bound may also be at least one fused-on, saturated, unsaturated or aromatic ring or a ring system having from 1 to 30 carbon atoms, where the ring or the ring system can have from 1 to 5 nonadjacent heteroatoms or heteroatom-comprising groups and the ring or the ring system can be unsubstituted or substituted,
where two geminal radicals R¹ to R⁴ may together also be ═O, ═S or ═NR^{b}, where R^{b} is hydrogen, alkyl, cycloalkyl, aryl or heteroaryl,
the radicals R, R¹, R², R³ and R⁴ can alternatively be alkanediyl, cycloalkanediyl, alkenediyl or cycloalkenediyl which links a cation of one of the formula (IV.e) to a further cation of the formula (IV.e); where these radicals additionally function, via their second point of bonding, as radical R, R¹, R², R³ or R⁴ of said further cation, and said radicals alkanediyl, cycloalkanediyl, alkenediyl and cycloalkenediyl are optionally branched, substituted and/or interrupted by at least one heteroatom or a heteroatom-comprising group;
where the anions of the at least one ionic liquid ILa are selected from among sulfates, sulfonates and carboxylates of the general formulae:
R^{c}OSO₃—, R^{c}SO₃— and R^{c}COO—;
where R^{c} is hydrogen, C₁-C₄-alkyl or C₃-C₇-cycloalkyl.

21. The mixture of ionic liquids according to claim 20, wherein the radicals R, R¹, R², R³ and R⁴ of the compounds of the formula (IV.e) are each, independently of one another, hydrogen, alkyl, cycloalkyl or acyl.

22. The mixture of ionic liquids according to claim 21, wherein radicals R and R¹ which are bound to a nitrogen atom are each, independently of one another, C₁-C₆-alkyl and the radicals R², R³ and R⁴ which are bound to a carbon atom are each hydrogen.

23. The mixture of ionic liquids according to claim 20, wherein the anions of the anionic liquids ILa and ILb are different from one another.

24. The mixture of ionic liquids according to claim 23, wherein the cations of the ionic liquids ILa and ILb are identical.

25. The mixture of ionic liquids according to claim 20, wherein the anions of the at least one ionic liquid ILb are selected from among anions of:
the group of carboxylates of the general formula:
R^{c1}COO—, where R^{c1} is C₅-C₂₆-alkyl;
the group of sulfates, phosphates, carbonates and sulfonates of the general formulae:
R^{c2}OSO₃—, R^{c2}SO₃—, R^{c2}PO₄2—, HR^{c2}PO₄—, R^{c2}R^{d2}₄—, R^{c2}CO₃—,
where R^{c2} is perfluorinated C₁-C₁₀-alkyl and R^{d2} is perfluorinated C₁-C₁₀-alkyl or C₅-C₂₆-alkyl;
the group of bis(sulfonyl)imides and sulfonylimides of the general formulae: 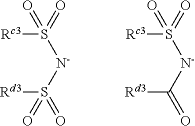
where the radicals R^{c3} and R^{d3} are each, independently of one another, fluorine, C₅-C₂₆-alkyl or perfluorinated C₁-C₁₀-alkyl; or together are optionally perfluorinated C₁-C₄-alkanediyl.

26. The mixture of ionic liquids according to claim 25, wherein the anions of the at least one ionic liquid ILb are selected from among the anions:

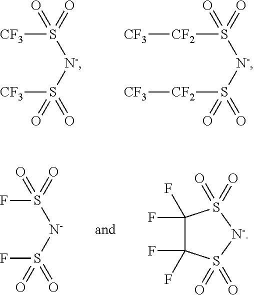

27. The mixture of ionic liquids according to claim 20, which comprises:
from 0.1 to 99.9% by weight of at least one ionic liquid ILa, and
from 0.1 to 99.9% by weight of at least one ionic liquid ILb, based on the total weight of ILa and ILb.

28. The mixture of ionic liquids according to claim 27, which comprises:
from 4 to 96% by weight of at least one ionic liquid ILa, and
from 4 to 96% by weight of at least one ionic liquid ILb, based on the total weight of ILa and ILb.

29. The mixture of ionic liquids according to claim 20, wherein the viscosity of the mixture at temperatures of from 20 to 100° C. is in the range from 1 to 1000 mPa·s.

30. The use of a mixture of ionic liquids according to claim 20 as operating liquid of a liquid ring compressor.
